(19) United States
(12) Patent Application Publication
(10) Pub. No.: US 2026/0340615 A1
(43) Pub. Date: Oct. 29, 2026

(54) SMART DIGITAL RECEIPTS TRANSMISSIBLE BY SHORT-RANGE COMMUNICATIONS FOR MULTI-DEVICE DATA PROCESSING SESSIONS

(71) Applicant: PAYPAL, INC., San Jose, CA (US)

(72) Inventors: Paul Robert Etienne Ostonen Peelen, Ingaro (SE); Eduardo Alejandro Solana Lopez, Danderyd (SE); Nancy Jain, Hägersten (SE); Samer Mlattialy, Stockholm (SE); Antonios Papantoniou, Arlington, TX (US); Savvas Viktor Grammatikopoulos Rosendahl, Järfälla (SE); Svadangs Karin Marit Alden, Stockholm (SE); Dmitrii Deplov, Haninge (SE)

(21) Appl. No.: 19/191,507

(22) Filed: Apr. 28, 2025

(51) Int. Cl. G06Q 20/20; G06Q 20/32

(52) U.S. Cl. CPC G06Q 20/209; G06Q 20/204; G06Q 20/327

(57) ABSTRACT

There are provided systems and methods for smart digital receipts transmissible by short-range communications for multi-device data processing sessions. A user may engage in a transaction with another user, such as a purchase of items from a merchant at a physical merchant location. The merchant may provide options for billing splitting pre-transaction and post-transaction, which may be provided through smart digital receipts transmissible to individual computing devices of the users. These digital receipts include selectable options for partial payments and/or selections of certain items that one user in a group may owe and thus may include embedded functionalities for separate payment processing through individual secure online sessions. Each digital receipt may be broadcast over short-range distance at a merchant location and may allow a nearby device to access the digital receipt and process a partial payment during a separate online session.

### TECHNICAL FIELD

The present application generally relates to transaction data splitting and sharing and more particularly to generating smart digital receipts pre-and post-transaction that allow establishment of separate online sessions for each transaction participant to process transaction data.

### BACKGROUND

Users may utilize online transaction processors for processing payments between different entities through device applications and digital accounts. Further, these online transaction processors may also provide payment options for in-person transaction processing and other digital account uses at merchant locations. As such, merchant customers of the online transaction processors may utilize in-person payment devices including card processing and/or payment terminals, point-of-sale (POS) devices that may include components and modules for local wireless exchanges of data and transaction processing, and/or merchant systems and servers for both local and national/world-wide sales, inventory, payment, and other merchant services, some of which may be offered and handled by the online transaction processors. Merchants may implement payment services and processing functionalities from transaction processors through these POS devices and/or other payment terminals.

Users may then pay utilizing payment instruments and/or funds, such as cash, credit or debit cards, mobile applications and digital wallets, and the like. Conventionally, merchants provided paper or other physical receipts to record and document transaction processing and payment, which users may later utilize for returns, tax purposes, budgeting, and the like. However, with the digital age of payment processing and data exchange, it has become increasingly popular and prevalent for merchants to provide digital receipts, such as through email or text. These processes though encounter several issues from both customer and merchant standpoints. Customers may be unsatisfied that their private information is taken by merchants, and often used for unwanted advertisements and offers, while also needing to go through repetitive contact information entry at different merchant locations. Merchants, on the other hand, need to handle privacy protected data in regulatory and legally compliant ways, while also having to ensure that receipts are properly delivered and there is a process to handle undelivered or old receipts.

Further, as these receipts are provided to customers and/or other users post-transaction, both customers and merchants may encounter a common problem when transaction participants want to split the bill. For example, it is common that friends may share a meal or purchase a group gift and thereafter wish to split the bill amongst the friend group prior to paying. This often leads to confusion between employees and customers, incorrectly split transactions, and/or times where certain payments are applied to the wrong items, such as a tip being applied to the underlying transaction items and not allocated to the wait staff or other employees. As a result, additional time and resources are needed to correct the transaction processing. Thus, it is desirable for merchants and other business entities to provide customers digital receipts that allow separation of transaction data for split processing in a more convenient and efficient manner, while allowing each of the separate data processing operations and transactions to be allocated to a proper categorization and portion of the central transaction or other event or data being processed.

### BRIEF DESCRIPTION OF THE DRAWINGS

FIG. 1 is a block diagram of a networked system suitable for implementing the processes described herein, according to an embodiment;

FIG. 2 is an exemplary system environment where smart digital receipts transmissible via short-range communications for multi-device data processing sessions are generated and/or used for multi-party transaction processing and other multi-device sessions, according to an embodiment;

FIGS. 3A-3F are exemplary diagrams of payment terminals and mobile devices with corresponding user interfaces displaying smart digital receipts when connecting to and/or communicating in different sessions for transaction processing, according to an embodiment;

FIGS. 4A-4C are exemplary flowcharts of different processes for generating, transmitting, and using smart digital receipts for multi-device data processing sessions, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for smart digital receipts transmissible by short-range communications for multi-device data processing sessions. Systems suitable for practicing methods of the present disclosure are also provided.

Bill splitting is typically done in one of four ways: 1) the individual payers from the group each providing a payment card, such as a credit card, to the merchant, who then allocates a portion of the total bill (whether equally or in another allocation) to each payment card, 2) the individual payers each providing cash to the merchant to cover their respective portion of the bill, 3) the individual payers each providing cash to one of the payers, who then pays the whole bill, or 4) a combination of two or more of the above.

With in-person transactions, bill or fee splitting is typically performed through inputs and/or transaction reconciliation by the merchant employees. This often involves an employee creating a first bill or transaction for all items, receiving instructions to split, and then recreating several smaller bills or transactions for individual items, which not only wastes the employees manual efforts spent inputting unnecessary transaction information into a first, unused bill, but also creates many opened transactions that end up not showing as closed, which can be problematic for computing systems that require transaction resolution and/or activity for accounting purposes. System resources are further wasted being used to store opened transactions in local memory, such as a data cache, instead of being able to archive closed transactions, leaving transactions incomplete or incorrect because items are missed between multiple transaction creations. The system then spends additional processing time creating transactions in an inventory and/or billing system that are then closed without payment or sale of the items, since certain ones of those items are not accounted for in different, smaller transactions. Consequently, bill splitting remains problematic for efficiency and accuracy of software products and backend processors of the online transaction processor. Further, with increasing use of digital payment methods, processing split payments may require the users to provide the merchant with identification information, such as an email address or mobile phone number, such that the merchant can send a digital receipt to the user or users. However, users may not want to share contact information for a variety of reasons, including not wanting to get unwanted communications such as marketing content or spam/phishing communications.

Thus, in various embodiments, an online transaction processor, as discussed herein, may provide operations that allow for faster and more convenient conveyance of digital receipts, as well as options and executable processes for those digital receipts to directly provide online session establishment for secure data processing and fee splits, all while avoiding unnecessary transaction creation, physical receipt provision, or the other conventional pitfalls involved with in-person transaction processing and receipt provision for split transactions or other multi-payment transactions. During checkout, a payment terminal device or other computing system may provide users with an option to “tap” to obtain a “page” or notification on the user's mobile, wearable, or other computing device, thereby turning the user's device to a pager. A tap may generally refer to an NFC or RFID “tap” or wireless data exchange that wirelessly communicates data over a short-range (e.g., 4-5 centimeters (cm) or less for NFC taps, which allows sharing of a small data payload between NFC devices and/or readers, however other distances are contemplated). A transaction may be generated at the payment terminal device, POS device, or other checkout device and with a backend payment processor server, which causes creation of a digital file and association with a particular webpage and/or webpage address for transaction recordation and payment processing. This may create a webpage or accessible online data that may be transmitted to a user's device through the short-range wireless communications and tap, and therefore the user is not required to enter contact or personal data, such as a contact identifier.

In this regard, a webpage address (e.g., a uniform resource locator (URL), uniform resource identifier (URI), or other file path and/or resource locator usable to identify data over a network) for the webpage including transaction tracking and payment using an NFC standard, such as NFC data exchange format (NDEF). This standard may be utilized for a message having message embedding that causes a browser application on a mobile device to open and execute the browser application and navigate to the webpage. The webpage or other loadable interface data in a browser, native software application interface, etc. may then be loaded in the corresponding application interface, which may occur without the user entering contact identifiers or other user contact information. Further, by utilizing short-range wireless communications (e.g., NFC communications limited to 4-5 cm of distance), sharing or theft of the order number, receipt, and other device may be minimized as any device being placed in such a proximity during data transmission would be able to be seen by the merchant, user, or another.

In a typical scenario, a user may desire to purchase items via available funds, a payment card, and/or a software application with a digital account at a real-world physical merchant location, such as a merchant storefront, retail location, or the like that provides in-person transaction processing through POS devices, payment terminals, and other merchant devices and systems. Selection of one or more items in an in-person transaction at a physical merchant location may require a payment instrument from the user for electronic transaction processing, which may be provided through a cash or other physical fiat currency, a payment card and embedded or encoded data (e.g., magnetic stripe, EMV chip, NFC chip, etc.), token, identifier, data package, or the like that is transmitted to a merchant device at the location. Payment may therefore be made via short-range wireless communications (e.g., contactless payments via NFC, RFID, etc.) using a digital wallet or other digital account for payment services of an online service provider or other transaction processor.

A digital account with an online transaction processor or another service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The user may also be required to provide financial information, including digital account (e.g., credit/debit card) information, bank account information, gift card information, benefits/incentives, and/or financial investments, when processing transactions with merchants and/or other users or entities. Account creation may also be used to establish account funds and/or values, such as by transferring money into the account and/or establishing a credit limit and corresponding credit value that is available to the account and/or card. An online transaction processor may also provide for tokenization of data for transaction processing. The application or website of the transaction processor, such as PayPal® or other online payment provider, may provide payments and the other transaction processing services. Moreover, the digital account may be utilized through one or more mobile applications for mobile devices or other software applications.

In order to pay for the transaction using the account (e.g., a transfer or payment to another user, merchant, or other entity), the user may provide the digital account or funding source information and/or may login to an account through authentication information in a software application. When providing in-person payments through payment terminals and a mobile device, a digital wallet may be utilized with the account to provide data to the terminal or device wirelessly. In this regard, an identifier and/or digital token or other data may authorize and/or authenticate the user for their digital wallet use and/or a payment instrument in the digital wallet (e.g., the account with the online transaction processor), which may be transmitted to another party for payment processing via wireless communications. This token, identifier, or other payment data may be anonymized, limited use, and/or include obscured or hidden payment or financial data, PII, or the like, which may prevent revealing a user's identity and/or information. The data for transaction and payment processing may be stored by and/or transferred using one or more storage mediums and/or wireless transceivers, such as an NFC/RFID component, fob, passive or active antenna, etc., a magnetic stripe or an EMV chip, a displayable code or data, or the like. A payment may then be issued to the other party to the transaction. A digital receipt or other transaction history may be optionally provided, or required to be offered/provided, to the user during and/or after transaction processing to document and record the transaction processing (including approval and payment or refusal and reason for refusal).

A receipt provided by a POS or payment terminal device of a merchant in this manner may include “smart” functionality, or embedded interface options and/or other selectable or interactable elements that may be presented in a user interface with the digital receipt. These elements, fields, buttons, or options that may be included as part of and/or encoded with the data for the digital receipt may enable the recipient device to establish a communication and/or online session with the transaction processor for transaction review, payment, and/or split payments and partial transaction payments (e.g., for a percentage of the bill or check, a subset of all of the items, a portion of a tax or tip amount, etc.). In this regard, a smart digital receipt may allow for users to set, configure, add, or remove certain items, fees, costs, tips/gratuities, etc. For example, with a tip, also referred to herein as a gratuity, a user may add an amount to a transaction, or be required to provide at least a certain base amount or percentage of the user's transaction costs. This tip or gratuity may correspond to an amount, percentage of transaction costs, or the like that the user has allocated or designated for the server, staff, service provider, or other user or entity as a payment for the products and/or services provided to the user. As such, tip, gratuities, and the like may refer to an amount added to a transaction. The smart digital receipt may be updated for each user and reflect a user's individual contribution to the tip total without allocating that tip or gratuity to the transaction total. This functionality of the smart digital receipt may allow for individual users to provide a tip amount without that tip amount being allocated to the transaction total and not for the intended tip or gratuity to be provided to the server or other user/entity that provided the products or services to the user.

A smart digital receipt may be presented from and/or on a website established by the transaction processor for that particular bill. Websites may be accessible from a browser in a browser application on the user's device, as well as dedicated software applications, and may output, present, and/or display the items in the transaction, as well as options selectable for items to be added to and/or deleted from purchase, searched, compared, etc. Thus, the digital receipt may not just record transaction information, but a digital receipt, as discussed herein, may also provide an array of functionalities through operations, processes, and dynamic data, presentable in an application or on a webpage corresponding to the receipt, and may be provided for performance and processing of the transaction, as well as other pre-and/or post-payment operations including bill splitting and/or item allocation to the responsible purchaser.

During or after processing and concluding a transaction, a POS device and/or payment terminal, or other merchant system and/or component, may prompt the user (e.g., customer or merchant employee) to determine whether the user would like a receipt and, if applicable to process the transaction via the receipt. If the customer or a merchant employee (e.g., a wait staff member) selects the option to transmit the receipt to the customer's device, such as the tap option for data exchanged via wireless NFC, RFID, or other short-range wireless protocol transmission, the payment terminal may then initiate a process to wirelessly broadcast and/or transmit data corresponding to the digital receipt. Further, the device or system may not ask, request, or require user contact information and/or identifiers when communicating with the merchant's device wirelessly at the merchant location and within a proximity range between the user's mobile device and the merchant's POS device, payment terminal, or other merchant system. Thus, the process may proceed independently from requesting and receiving such personal and/or contact data. This process may correspond to a “two-tap solution,” as described herein. In such a solution, the user may initially tap their device to the POS device, payment terminal, or other payment device and then choose from options, after which payment may be provided by performing a second tap or having the user's device transmit a payment request to a transaction/payment processor for processing. However, in one-tap solutions, the user's “option” for receiving the digital receipt, tip, payment, and the like may be implied and a single tap may cause payment processing with the merchant's device and/or transaction/payment processor.

A display device, component, or other output component may begin displaying instructions to wireless connect and/or communicate with the merchant's device to receive data for the digital receipt on the user's device, such as an instruction to “tap” the user's mobile or wearable device (e.g., mobile smart phone, smart watch, etc.) to a particular component or area of the POS device, payment terminal, or the like. The “tap” area may be indicated by the display device and/or by markings or configuration of the merchant's device and/or checkout infrastructure, and may include the short-range wireless transmitter, antenna, or transceiver, which may provide for broadcasting of data wirelessly to nearby devices. The payment terminal may also display an indicator, message, or other information that indicates when and for how long the data is being broadcast, such as a “Tap Now!” or “Sending!” message to indicate the broadcasting is occurring. Further, where the wireless NFC, RFID, or other short-range wireless protocol transmissions are unsuccessful or incompatible, a code, such as a quick response (QR) code, may be displayed on the merchant's device that includes encoded data for fetching or navigating to the website, retrieving the digital receipt, and the like.

In order to perform the broadcast of data that may send and/or populate the webpage or application interface data for the digital receipt on a customer's device, the payment provider, transaction processor, or other service provider may create data for a webpage or other pathway that hosts and/or provides a notification and/or notification data that may track an order, such as by being updated when changes to the order's status are received from the merchant's device or backend system. When a digital receipt is created for a transaction, data for the transaction may be generated in computer code, such as webpage code, that may be presentable via a webpage. This may be done automatically and procedurally based on a template for the webpage and dynamic data for the transaction insertable into webpage fields, menus, elements, or the like. The transaction may therefore be generated and/or converted to webpage or other application interface data that may be presentable in an application on the customer's device. A message or notification may also be generated that conveys a link to other data that causes a navigation to the webpage and/or application data in the application, which may then load the webpage or application interface data.

As such, the message or notification may include and/or correspond to message content and/or a message structure having a webpage address, a file path, and/or a data file, such as an extensible markup language (XML) or hypertext markup language (HTML) file or object that may be loaded in and/or a web browser application or in a software application interface (e.g., interface of a mobile application on a mobile device) in response to receiving the data. In some embodiments, the data for the digital receipt and/or webpage may correspond to JavaScript Object Notation (JSON) data, such as JSON objects, containers, and/or data files The message content or other message data may cause a navigation to, and/or opening of, a webpage address, link, or data file. In this regard, a transaction processor and/or online webpage indexing and hosting systems may be utilized to generate the corresponding file and/or webpage.

The webpage or file may include information for the transaction which may be pending or completed. This information may include items or services, merchant location and/or merchant information, prices and costs, date and time, tax or other fees, tip or other additional gratuities and expenses, and the like. As previously noted, gratuities may include and/or refer to tips or other amounts added to a transaction by a user that is allocated or designated for the server, staff, service provider, or the like as an additional payment for the services and/or products provided to the user. As such, gratuities or tips may include a form field on the webpage and for the digital receipt that allows for user input/selection by the user and/or automatic entry by the merchant (e.g., for a required tip amount, such as 18% for parties meeting or exceeding a certain size), which may further be configurable by the user to select an amount, percentage of the bill or user's portion of the bill, etc. Further, a dynamic and/or updateable field, webpage/interface element, or other data on the webpage or in the interface may include the options for transaction payment (e.g., when the transaction is pending, ready for payment, required closure or payment, etc.).

This dynamic and/or updateable field may be updated and changed as the merchant's device communicates with the service provider's backend to track, monitor, and/or update order status and provide such information to the user by allowing the user's device to access the webpage and/or application interface data that includes the current status information. The data file and/or webpage may then be stored, cataloged, and/or persisted to make available via the corresponding address, link, file path, or the like. The service provider's backend may be used as a centralized system and/or repository that allows for sharing of the order status and pager notifications with the user's mobile device.

To share the data with the user's mobile device, different communication pathways and channels may be utilized. As discussed above, an online transaction processor or other service provider may generate a message, message content, and the like for broadcasting via the short-range wireless communications utilized by the POS or payment terminal device, or another merchant system/component. The message may be generated to include the webpage address in the message or other link, address, file path, or the like for webpages and/or application data (e.g., for display via application interfaces). In this regard, the message may have a field, portion, or the like that includes the webpage address or may link to the webpage through encoded data, such as by having the address embedded in a message header, body, etc. The message may automatically cause a computing device, automatically and without further user input directly associated with accessing the webpage of the merchant to navigate to the webpage of the digital receipt and load the digital receipt in a web browser or application interface of the application. Thus, the customer's, or other user's, device receiving the message may be instructed to open or execute a web browser application or dedicated software application and navigate to the webpage. Where application user interfaces may be used instead of browsers, such as for in-application website display, to populate an interface notification or element notifying the user of the webpage, webpage, the data may be loaded within the appropriate application interface.

The message may also cause other applications to open and/or load the webpage or data accessible at the link or file path in one or more interfaces. Such opening and/or loading may be done automatically or after accepting an interface prompt and request based on the computing device receiving the message. For example, a mobile device may be configured with NFC protocols (e.g., NDEF) and operations to receive NFC messages having web addresses embedded in a particular portion, which causes the mobile device to load and navigate to such address in a web browser application. This would then cause the webpage file to be loaded for the smart digital receipt having session capabilities for online transaction processing. If a failure to exchange data occurs, the merchant and/or user may select an option for other transmission of the data via a displayable code on a display component of the merchant's device, such as a Quick Response (QR) code, which may be captured by the user's device using a camera, code scanner, or the like.

In a second scenario, when paying for the transaction, the user's mobile device may obtain the digital receipt over the network using a network address for the receipt provided. The user's mobile device may be used for a “tap-to-pay” type feature where a payment may be made through NFC data exchange. The NFC or other short-range communications and signals may be used to provide information usable by the transaction processor backend to send the receipt to the mobile device of the user, but which may not identify the user and/or the user's contact information to the merchant's device or system. The transaction processor, after generating the webpage and/or application interface data, as described above, may then share, push, transmit, or otherwise provide the data to the user's device directly over a network connection, such as a cellular data network. This may occur without relaying the data through the merchant's device or providing personal or contact information to that device. This also does not require the user's device to be tapped again to the merchant's device. Other scenarios may also be used for exchange of an identifier to have the service provider's backend push or provide data to the user's device, as well as processes to share data without identifier exchange between the user's device and the merchant device (e.g., WiFi, Bluetooth, etc.).

When the user's mobile device receives the message, the digital receipt may be displayed and the user may select items for purchase in a sub-transaction, secondary transaction, side transaction, or split payment/transaction process. As each item is paid for and payment is processed, the transaction and digital receipt may be updated via the webpage and webpage data, which may be reflected on the digital receipt. Since split transaction processing may occur prior to transaction closure and full payment (e.g., while the transaction is pending, or post transaction processing), updates may be synchronized or asynchronously as needed to provide real-time updates to the customers, merchant, and/or transaction processor. With pre-transaction closure and processing, the checkout session may be moved or converted to an online session, and different online sessions for each sub-transaction or secondary transaction to be processed for full transaction completion may be created and/or branched off from this session for each device requesting processing of a partial amount, certain items, etc. The transaction processor may utilize these sessions for transaction processing and payment and may provide real-time updates to and changes of the transaction and receipt as items are selected, purchased, and/or fulfilled for payment and checkout closure. However, with post-transaction processing, the checkout session has already been closed and the transaction paid for in a completed transaction, which requires recordation and proper storage and accounting. As such, new online sessions for each further transaction to split the bill may require new creation and processing and may be used to update the digital receipt recording the first transaction that was processed.

In this manner, digital receipts may be easily transmitted to customers and other users without requiring users to enter contact and/or personal data, thereby increasing online and digital user privacy protection. The digital receipts may include executable processes and embedded features to provide faster, more efficient, and less error prone processing of multiple different digital payments and corresponding data, thereby providing better allocation and usage of system resources for data processing and storage and reducing the number of errors introduced from opening but not processing multiple digital transactions and files. The digital receipts may allow for a centralized process to track multiple different data processing events associated with the main transaction, which may be used to provide faster and real-time updates to transactions that correlate different payments to certain payment types and items. This allows merchant systems to better comply with both accounting requirements and privacy regulations, thereby ensuring that merchant computing systems are regulatory compliant and provide fast and efficient data processing operations. As such, online transaction processors and the merchant computing systems they service may be made to be faster, more secure, and more efficient for digital transaction processing for split payments and receipt services.

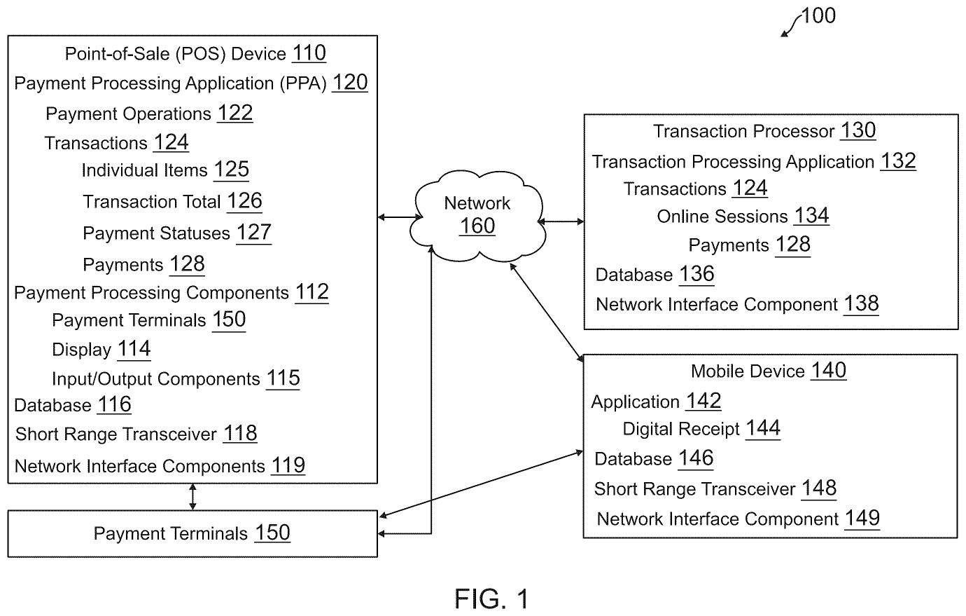

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a point-of-sale (POS) device 110, a transaction processor 130, a mobile device 140, and payment terminals 150 in communication over a network 160. POS device 110 and/or mobile device 140 may be used to establish a transaction and process a payment for the transaction. In this regard, when the transaction is generated and/or processed, a digital receipt for transaction data may be created between POS device 110 and transaction processor 130, which may then be provided to mobile device 140. Transmissions from POS device 110 and/or payment terminals 150 to mobile device 140 may occur over short-range wireless communications, as well as responsive transmissions from mobile device 140, without requiring the user associated with mobile device 140 to enter or provide personal information and/or contact identifiers directly to POS device 110 and/or payment terminals 150.

POS device 110, transaction processor 130, mobile device 140, and/or payment terminals 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

POS device 110 may be implemented using any appropriate hardware and software configured for wired and/or wireless communication with computing devices, such as those associated with customers including mobile device 140. As such, POS device 110 may correspond to a single or all-in-one system for a merchant device, POS device and/or checkout register, or the like. However, in other embodiments, handheld card readers, dongle devices, card swipe or tap readers, and the like, such as those corresponding to payment terminal 150 that integrate locally and/or on the back end with POS device 110 or the corresponding merchant system may also be used for processing a transaction, reading card or mobile phone data, transmitting and/or receiving (including broadcasting in a manner that does not directly target another device) short-range wireless communications transmitted using a short-range wireless protocol including NDEF.

Although discussed as different devices with regard to system 100, in different embodiments, POS device 110 and payment terminals 150 may correspond to the same device or be incorporated into a single device that may be configured to provide payment processing at merchant and/or POS locations through communications with transaction processor 130 over network 160. However, in other embodiments, POS device 110 and payment terminals 150 may correspond to separate devices that interact to provide payment processing as discussed with regard to FIG. 1. In various embodiments, POS device 110 may be implemented as a personal computer (PC), a payment terminal device with payment processing components, a smart phone, laptop/tablet computer, wristwatch with appropriate computer hardware resources, other type of wearable computing device, and/or other types of computing devices capable of transmitting and/or receiving data. Although a single POS device is shown, a merchant location may have multiple POS devices, each having the same, similar, or different capabilities and/or connected peripheral devices including payment terminals 150.

POS device 110 of FIG. 1 contains a payment processing application (PPA) 120, payment processing components 112, a database 116, a short-range transceiver 118, and a network interface component 119. PPA 120 and payment processing components 112 may correspond to executable processes, procedures, and/or applications with associated hardware, such as computer processors. In other embodiments, POS device 110 may include additional or different modules having specialized hardware and/or software as required.

PPA 120 may correspond to one or more processes to execute software modules and associated components of POS device 110 to provide features, services, and other operations for payment processing with a merchant POS device and/or over network 160 with transaction processor 130, which may include processes to provide “smart” or functional digital receipts including intelligently selected and configured receipt processes, selectable elements or fields, and connectable online sessions. The functional digital receipts may facilitate transaction processing including split payments, transactions, and/or transaction fees in a simplified manner with single user and/or sub-transaction or secondary transaction payment processing that can be combined in a single larger transaction for recordation together for a single transaction due and/or providing a repayment history for a past paid transaction.

In this regard, PPA 120 may correspond to specialized software utilized by a user of POS device 110 that may be used to access a website or application (e.g., mobile application, rich Internet application, or resident software application) that may display one or more user interfaces that allow for interaction with the computing services of transaction processor 130 for payment processing. In various embodiments, PPA 120 may correspond to a general browser application configured to retrieve, present, and communicate information over the Internet (e.g., utilize resources on the World Wide Web) or a private network. For example, PPA 120 may provide a web browser, which may send and receive information over network 160, including retrieving website information, presenting the website information to the user, and/or communicating information to the website. However, in other embodiments, PPA 120 may include a dedicated application of transaction processor 130, a merchant system or merchant device, or other entity.

PPA 120 may include payment operations 122, which may be used to process payments with users. For example, payment operations 122 may be used to receive and/or generate a transaction to purchase one or more items or services, such as by receiving item or service input and selection through item scanning, menu or interface selections and input, receipt of a transaction or order from another device or server (e.g., generated by mobile device 140 and provided to POS device 110 for processing and/or fulfillment), and the like. Payment operations 122 may further request payment for the transaction from one or more users, which may be provided using cash and merchant input, a check and merchant input and/or a check reader, a payment or gift card using a card reader (e.g., magnetic stripe reader, EMV or RFID chip reader, etc.), and/or a contactless payment terminal and component for mobile application payments from mobile devices (e.g., via NFC, RFID, QR code scanning, etc.). PPA 120 may process a transaction and/or a payment request using payment data from one or more contactless payment devices, terminals, transceivers, or the like, as well as merchant input (e.g., cash or check transactions).

For example, PPA 120 may process transactions 124 for individual items 125 that have been added to and/or combined together in a transaction requiring checkout, payment, or fulfillment/delivery/completion. Individual items 125 may have a transaction total 126, which may include a sum of individual items 125, as well as any tax, tip, or other transaction fees and costs. While multiple items may generally be split in a transaction between multiple users, in some embodiments, one or more of transactions 124 include a purchase of a single item or have one payment due, such as the purchase of a gift or present for another user, where multiple users may split that single cost and payment together, as discussed herein. Payment processing may be performed and payment statuses 127 may be updated, such as “payment due,” “payment pending,” “no payment received,” “partial payment received,” “$X. XX received” (or other amount identifying the amount so far paid,” “payment completed,” and the like. As such, payment statuses 127 may be updated based on payments 128, and may provide information for payments 128, such as the users that have paid, account or other identified that have sent payment, and the like.

Payment operations 122 may allow a merchant and/or user to enter, receive, and process transactions 124 using payment data for payments 128. In this regard, payment operations 122 may utilize payment processing components 112, short-range transceiver 118, and/or network interface component 119 for data entry and/or communication with other devices, peripheral devices or components, and/or systems and servers. Thereafter, PPA 120 may be used to view the results of transaction processing and the like via one or more interfaces, which may include a receipt or other transaction history that may be transmitted to mobile device 140 or another endpoint/address and/or printable on a physical receipt. As such, a physical copy of a receipt showing the pending and/or paid for transactions may be available from POS device 110, and PPA may provide the data for the digital receipt and pending or processed transaction to transaction processor 130 and/or mobile device 140 for digital receipt creation with embedded and/or encoded elements, options, and the like for split payments and other additional transaction processing options.

PPA 120 may be used by customers and/or merchant employees for selection of short-range wireless transmissions of digital receipts or other receipt data independent of requiring a user to provide input for an email address, phone number, or the like for receipt data transmission. For example, payment processing components 112 for transactions 124 may include payment terminals 150 for user selections for processing of and/or obtaining digital receipts for transactions 124, as well as a display 114 usable to output transaction data, total, items, and the like, as well as update each transaction as partial payments are made. Payment may be completed, or payment may be pending, and further transactions or side/sub-/secondary transactions may be processed through online sessions 134 for individual users and with their corresponding devices. This may be done using functionalities and operations provided on or embedded/encoded in the digital receipts, such as digital receipt 144 provided on mobile device 140 and/or one or more other computing devices of payers and/or transaction participants. A “tap-to-pay” or “tap-to-receipt” option may be selectable via payment terminals 150, display 114, and/or input/output components 115, which may initiate a broadcast of a message over short-range wireless communications and alert one or more users that digital payments and receipts are available to be received on mobile device 140.

If the option is selected to receive a digital receipt on mobile device 140, data may be exchanged via an NFC or similar tap, or short-range wireless communications within a proximity range (e.g., bringing mobile device 140 within 4-5 cm of POS device 110 and/or short-range transceiver 118 of POS device 110 for NFC transmissions). Receipt data for one of transactions 124 may be generated, such as an identifier (e.g., alphanumeric code, such as a number) for the transaction, individual items 125 included in the transaction, transaction total 126, and the like. The digital receipt may include one or more selectable options, fields, menus, and/or elements that allow for selection of specific items from individual items 125 to purchase, as well as any payment of fees, tip, tax, and the like. Payment statuses 127 may be used to track payment fulfillment and/or completion and a webpage and/or data for an application interface may be generated by transaction processor 130 for the digital receipt and processing of payments 128 through online sessions 134 established by each device when opening the webpage and/or loading the payment processing operations in a browser, application, or the like.

The data for the digital receipt and transaction may correspond to a file, document, or data object that includes transaction data from transactions 124 and/or a dynamic field or updateable portion for payment statuses 127 and/or processing of payments 128 through payment processing fields, menus, and/or operations. For example, an XML or HTML file may be generated by transaction processor 130, where the file may be associated with a network pathway and address (e.g., a webpage address for a webpage that loads data) accessible via a corresponding webpage address, link, loading event, file path, or the like for retrieval of the webpage and/or application interface data. The webpage address may navigate to the webpage that causes loading of the file from the corresponding pathway, such as an online or cloud storage system. The webpage address may be added to, included/embedded in, and/or used to generate a message, notification, or the like for a corresponding digital receipt, such as digital receipt 144, which may be transmitted to mobile device 140 and/or other mobile and client computing devices over short-range wireless communications so that the digital receipt and corresponding webpage and/or interface data may be loaded in a browser, application interface, or the like and payments may be processed for all or part of the corresponding one of transactions 124. These payments may occur prior to transaction completion and closing out or may be done after as reimbursement transactions to an original payer of the transaction.

As such, PPA 120 with payment processing components 112 may generate a digital message or communication that may be broadcast via the short-range wireless communications to a device within a range or proximity of POS device 110, such as mobile device 140 when mobile device 140 is tapped or placed within a certain range for NFC or similar transmissions. A message for a digital receipt may be generated using a messaging protocol for the short-range wireless communications used, such as an NFC transmittable message. The webpage address, file path, or other link, URI or URL, or the like may be added, embedded, or otherwise provided with the message so that the message may cause mobile device 140 to prompt for or automatically navigate to the webpage using the webpage address or load application data for an application interface, which causes loading, display, and/or output of the digital receipt having selectable and/or interactable fields, menus, options, and/or elements for split payment processing and payment or repayment tracking.

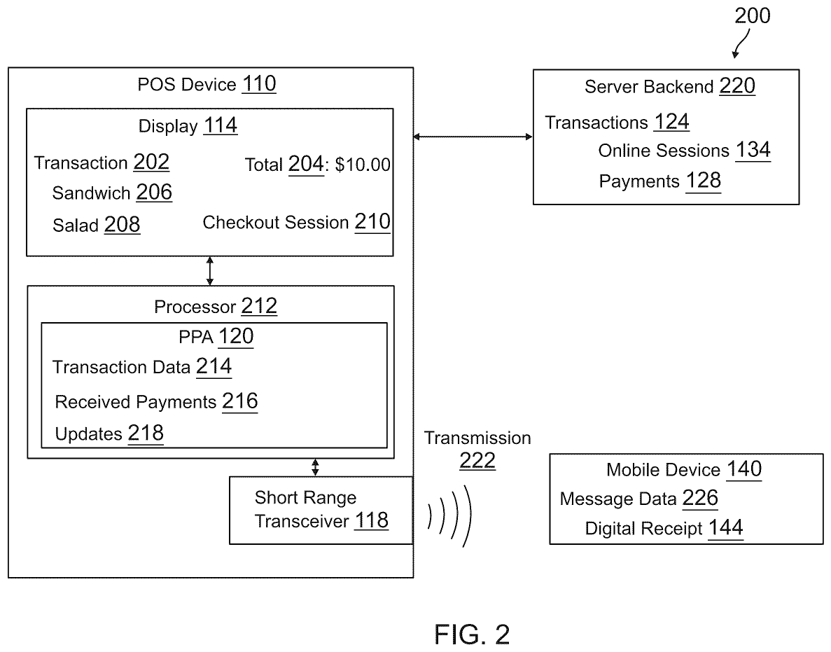

Once generated, payment processing components 112 and/or short-range transceiver 118 may be used to broadcast the message over short-range wireless communications. For example, POS device 110 may utilize short-range transceiver 118 to transmit the message using a short-range wireless messaging protocol and technology. While short-range wireless communications, transmission, and protocols are described herein, and may refer to NFC transmissions and protocols that, in certain embodiments, may be used to transmit data between devices in close proximity or short range (e.g., 4-5 cm), other wireless technologies may also be used (e.g., RFID, Bluetooth, WiFi, etc.). The message may be broadcasted for a set amount of time, until received, and/or until a stoppage of broadcasting is requested. The message may be broadcast continuously or periodically and may be limited to a certain distance or proximity when transmitting. Examples of smart digital receipts having embedded and/or encoded functionalities for split payment processing and/or multi-payment transactions are further discussed with regard FIGS. 2A-4 below.

In various embodiments, POS device 110 includes other applications as may be desired in particular embodiments to provide features to POS device 110. For example, the other applications may include security applications for implementing client-side security features, programmatic client applications for interfacing with appropriate application programming interfaces (APIs) over network 160, or other types of applications. In various embodiments, the other applications may include various types of financial applications, such as banking, financing, underwriting, and/or loan applications and the like. The other applications may include device interface applications and other display modules that may receive input from the user and/or output information to the user. For example, the other applications may contain software programs, executable by a processor, including a graphical user interface (GUI) configured to provide an interface to the user. The other applications may use payment processing components 112 of POS device 110, such as display 114 capable of displaying information to users and other output devices, including speakers.

Payment processing components 112 of POS device 110 may be used to provide additional functionality and assist in transaction and payment processing. In this regard, payment processing components 112 may include and/or be connectable with data readers, which may be configured to read data from payment cards, gift cards, mobile devices, key fobs, and the like. The data read from such devices may include payment data, and therefore data readers may include magnetic stripe readers, EMV chip readers, NFC card of fob device readers, and the like. Payment processing components 112 further include display 114, which may be configured to output and display data to the user and/or merchant. Display 114 may be used during transaction processing to display transaction processing input, results, and the like. This may include prompts for payment data input, receipt conveyance channel selection, and the like. While broadcasting a message for a digital receipt via short-range wireless communications, display 114 may also be used to display, when the message is being broadcast, if message transmission is successful or receipt acknowledged, and/or a remaining time or end of broadcast. Ending the broadcast may cause display 114 to provide a prompt to rebroadcast or transmit via another process, such as a QR code. In this regard, payment processing components 112 further include input/output components 115, such as buttons, a keyboard, a mouse, a touch screen interface, and the like, which enable the aforementioned inputs and selections to be made, as well as output components that may be used to view input as it is made, prompts for input to be provided and the type of input to provide, and/or receive and convey other information to users during the course of transaction processing and/or digital receipt transmission and use.

POS device 110 may further include database 116 stored on a transitory and/or non-transitory memory of POS device 110, which may store various applications and data and be utilized during execution of various modules of POS device 110. Database 116 may include, for example, identifiers such as operating system registry entries, cookies associated with PPA 120 and/or the other applications, identifiers associated with hardware of POS device 110, or other appropriate identifiers, such as identifiers used for payment/user/device authentication or identification, which may be communicated as identifying the merchant and/or POS device 110 to transaction processor 130. Moreover, database 116 may include data for digital receipts, orders and order tracking, and the like, which may include transactions 124 including individual items 125 for transaction totals 126, as well as payment statuses 127 for payments 128.

POS device 110 may include at least one short-range transceiver 118 adapted to communicate with mobile device 140, payment terminals 150, and/or other nearby devices, transceivers, and/or components through short-range wireless signaling and communications including NFC communications, RFID communications, Bluetooth, WiFi, infrared scanners and/or communicators, and the like. In various embodiments, short-range transceiver 118 may correspond to microwave, RF, infrared, Bluetooth, and NFC devices and components. In some embodiments, POS device 110 and mobile device 140 may communicate directly, without the use of network 160, for transaction and/or digital receipt processing. In this regard, POS device 110 may also use visual data transmission, such as display, using a display device, or a machine-readable code (e.g., a QR code) having encoded data for the digital receipt and/or webpage. As such, display components and cameras may further be used for data transmissions between devices including POS device 110 and mobile device 140.

POS device 110 includes at least one network interface component 119 adapted to communicate with transaction processor 130, payment terminals 150, mobile device 140, and/or other devices and servers over network 160. In various embodiments, network interface component 119 may include a WiFi component, a DSL (e.g., Digital Subscriber Line) modem, a PSTN (Public Switched Telephone Network) modem, an Ethernet device, a broadband device, a satellite device and/or various other types of wired and/or wireless network communication devices.

Transaction processor 130 may be maintained, for example, by an online service provider, which may provide processes to provide account services and process payments. In this regard, transaction processor 130 includes one or more processing applications which may be configured to interact with POS device 110, mobile device 140, payment terminals 150 and/or another device/server to facilitate communications for transactions, payment processing, and receipt provision for merchants and users including use of digital receipts having elements that enable split transaction processing for multiple transaction participants. Transaction processor 130 may be maintained by or include another type of platform or service provider, for example, a transaction processor such as PAYPAL®, Inc. of San Jose, CA, USA.

Transaction processor 130 of FIG. 1 includes a transaction processing application 132, a database 136, and a network interface component 138. Transaction processing application 132 may correspond to executable processes, procedures, and/or applications with associated hardware. In other embodiments, transaction processor 130 may include additional or different modules having specialized hardware and/or software as required.

Transaction processing application 132 may correspond to one or more processes to execute modules and associated specialized hardware of transaction processor 130 to process transactions 124 with POS device 110 and/or mobile device 140 based on in-person, short-range wireless, and/or contactless payments, data transfers, communications, and the like. In this regard, transaction processing application 132 may correspond to specialized hardware and/or software used by users to establish accounts and/or engage with electronic transaction processing services. Accounts may each be created by providing personal and/or financial information to transaction processor 130 and selecting authentication credentials. In various embodiments, the financial information may include payment instrument information, such as account/card numbers or other payment, user, and/or financial information. An account may be used to purchase items and/or transfer funds, as well as create a digital wallet that may be used for various transaction processing purposes and services. The payment account may be accessed and/or used through a browser application and/or dedicated payment application. Transaction processing application 132 may process a payment and may provide a transaction history for transaction authorization, approval, or denial.

Transaction processing application 132 may correspond to a service of transaction processor 130 that may be utilized by end users, such as to perform electronic payments, transfers, and the like using one or more accounts and/or financial instruments. Transaction processing application 132 may also include or utilize different processors, engines, or models as required for an authentication, account setup and maintenance, electronic transaction processing, deposit and/or withdrawal, dispute resolution, and the like. Transaction processing application 132 may be used for digital receipt creation and/or generation for transactions 124, which may correspond to creation of a webpage and/or webpage data that can be hosted and/or provided over network 160 to requesting devices. The webpage may include functions and operations for payment processing, which may be done by multiple users for portions of each of transactions 124 through online sessions 134. For example, during some of online sessions 134, payments 128 may be requested/selected (from selection of individual items 125, an amount of transaction 126, or the like), processed, and completed for a subset of items in the corresponding transaction.

As such, for each one of online sessions 134 where one of payments 128 is processed, transaction processing application 132 may track and add that amount to fulfillment of a total amount of the required payments. Online sessions 134 may correspond to separate and secure online communication sessions between two endpoints, one of which including transaction processing application 132 or other payment processor. For example, online sessions 134 may correspond to an information exchange or other exchange of digital communications between application 142 on mobile device 140 and transaction processing application 132, which may be used for payment processing including split payments. As such, each of online sessions 134 may occur as a result of a checkout session for a corresponding one of transactions 124, and may provide separate checkout and/or payment sessions for sub-transactions, secondary transactions, and/or split transactions and/or payments from that checkout session. Payment statuses 127 may be updated, and the corresponding digital receipt may reflect this change both on the website and in the corresponding browser, application, or the like.

Transaction processing application 132 may include one or more API integrations and/or interactions with POS device 110, application 142 and the same or similar application on other computing devices, payment terminals 150, and/or payment networks in order to detect, receive, and monitor payments 128 for transactions 124 and update digital receipts, as well as perform other digital receipt transmissions, forwarding or user-to-user communication, and the like. For example, a digital receipt may correspond to XML/HTML files or other data for webpages and the like where notifications may be hosted for orders and order statuses, including providing payment processes, item selection options, and/or payment status 127 in a webpage field, area, element, or the like. Modern web technologies that may enable these functionalities and features of webpages, data transmissions, dynamic digital receipts, and the like may include JSON objects, containers, files, and the like. The digital receipt may also correspond to application data displayable by one or more user interfaces, such as the data necessary to display an application interface having a notification regarding digital receipt 144 on mobile device 140.

Transaction processing application 132 may correspond to one or more processes to execute modules and associated specialized hardware of transaction processor 130 to process a transaction or provide another service to customers, merchants, and/or other end users and entities of transaction processor 130. In this regard, transaction processing application 132 may provide computing services to users, which may include electronic transaction processing and/or other computing services using accounts provided by transaction processor 130, such as in response to receiving transaction data for electronic transaction processing of transactions. In some embodiments, transaction processing application 132 may be used by users, such as a user associated with mobile device 140, to establish user and/or payment accounts, as well as digital wallets, which may be used to process transactions. Accounts may be accessed and/or used through one or more instances of a web browser application and/or dedicated software application executed by mobile device 140 and engage in computing services provided by transaction processing application 132. Computing services of transaction processing application 132 may also or instead correspond to messaging, social networking, media posting or sharing, microblogging, data browsing and searching, online shopping, and other services available through transaction processor 130.

In various embodiments, other applications may be desired in particular embodiments to provide features to transaction processor 130. For example, transaction processing application 132 may include security applications for implementing server-side security features, programmatic client applications for interfacing with appropriate application programming interfaces (APIs) over network 160, or other types of applications. Transaction processing application 132 may contain software programs, executable by a processor, including a graphical user interface (GUI), configured to provide an interface to the user when accessing transaction processor 130 via one or more of POS device 110 and/or mobile device 140, where the user or other users may interact with the GUI to view and communicate information more easily. In various embodiments, transaction processing application 132 may include additional connection and/or communication applications, which may be utilized to communicate information to over network 160.

Additionally, transaction processor 130 includes and/or is able to access database 136. Database 136 may store various identifiers associated with mobile device 140. Database 136 may also store account data, including payment instruments and authentication credentials, as well as transaction processing histories and data for processed transactions. Database 136 may store received data associated with a user, such as transaction data and payments for transactions. Although database 136 is shown as residing on transaction processor 130 as a database, in other embodiments, other types of data storage and components may be used including cloud computing storage nodes, remote data stores and database systems, distributed database systems over network 160 and/or of a computing system associated with transaction processor 130, and the like.

In various embodiments, transaction processor 130 includes at least one network interface component 138 adapted to communicate with POS device 110, mobile device 140, payment terminals 150, and/or another device/server over network 160. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Mobile device 140 may be implemented using any appropriate hardware and software configured for wired and/or wireless communication with merchant devices, payment terminals, contactless payment transceivers and devices, and/or transaction processor 130 for processing a transaction and receiving a digital receipt independent or without of providing or inputting data that may be used to contact a user or other personal data of the user. Mobile device 140 may correspond to a user that processes payments and sales through an executable software application, which may include split transactions, payments, and/or fees with other users and/or computing devices. In various embodiments, mobile device 140 may be implemented as a personal computer (PC), a smart phone, laptop/tablet computer, wristwatch with appropriate computer hardware resources, other type of wearable, mobile, and/or implantable computing device, and/or other types of computing devices capable of transmitting and/or receiving data. Although only one mobile/user device is shown, a plurality of mobile/user devices may function similarly, where additional mobile devices are associated with other users who participate one or more of transactions 124 for split payments, partial payments or the like.

Mobile device 140 of FIG. 1 contains an application 142, a database 146, a short-range transceiver 148, and a network interface component 149. Application 142 may correspond to executable processes, procedures, and/or applications with associated hardware. In other embodiments, mobile device 140 may include additional or different modules having specialized hardware and/or software as required.

Application 142 may correspond to one or more processes to execute software modules and associated components of mobile device 140 to provide features, services, and other operations for a user over network 160, which may include accessing and utilizing computing services provided by transaction processor 130. In this regard, application 142 may correspond to specialized software utilized by a user of mobile device 140 that may be used to access a website or application (e.g., mobile application, rich Internet application, or resident software application) that may display one or more user interfaces that allow for interaction with the computing services of transaction processor 130. In various embodiments, application 142 may correspond to a general browser application configured to retrieve, present, and communicate information over the Internet (e.g., utilize resources on the World Wide Web) or a private network. For example, application 142 may provide a web browser, which may send and receive information over network 160, including retrieving webpage information including a webpage where digital receipt 144 is accessible and/or may be interacted with for payment processing and/or split payment allocation, presenting the webpage information to the user, and/or communicating information to the webpage. However, in other embodiments, application 142 may instead correspond to a dedicated or mobile software application of transaction processor 130, a merchant, or another entity, which may allow for opening and/or navigating to webpages, interfaces, and the like to display and output digital receipt 144 based on data for an application interface.

In this regard, application 142 may be activated, opened, and/or executed in response to a message from POS device 110, where the message may include information, executable commands, embedded data, encoded data and/or commands that cause digital receipt 144 to be loaded in the corresponding browser or other application interface. For example, the message may include a webpage address to access digital receipt 144 from a webpage and load the data for the receipt. In some embodiments, the webpage address may be added to a message content, field, or the like, such as a message header, body or content field, or the like using a corresponding message protocol (e.g., NDEF) to prompt for navigation to or automatically navigate to digital receipt 144. Once loaded, the “smart” capabilities and features of digital receipt 144 may be utilized through application 142, which may include split payment processing, viewing of payment statuses 127 and/or payments 128, or determining a completion status and/or repayment history for transaction total 126 from one or more other users.

Application 142 may be associated with account information, user financial information, and/or transaction histories including digital receipt 144. However, in further embodiments, different services may also be provided via application 142, including social networking, media posting or sharing, microblogging, data browsing and searching, online shopping, and other services available through transaction processor 130. Thus, application 142 may also correspond to different service applications and the like. When utilizing application 142 with transaction processor 130, application 142 may request processing of a transaction, such as a payment request with transaction processor 130 for all or a portion of transaction total 126, which may include selection of specific ones of individual items 125. Application 142 may establish a private and/or secure online session with transaction processing application 132 of transaction processor 130, and may process one or more of payments 128, which may correspond to a pre-transaction closure split payment or may correspond to a post-transaction repayment for later bill splitting between transaction participants that owe an original payer participant an amount for reimbursement of their share of one of transactions 124. Application 142 may be used to view the results of transaction processing and the like via one or more interfaces, such as digital receipt 144 in response to receiving a broadcast of the correspond message for the digital receipt by POS device 110.

In various embodiments, mobile device 140 includes other applications as may be desired in particular embodiments to provide features to mobile device 140. For example, the other applications may include security applications for implementing client-side security features, programmatic client applications for interfacing with appropriate application programming interfaces (APIs) over network 160, or other types of applications. The other applications may also include email, texting, voice and IM applications that allow a user to send and receive emails, calls, texts, and other notifications through network 160. In various embodiments, the other applications may include financial applications, such as banking applications. Other applications may include social networking applications, media viewing, and/or merchant applications.

The other applications may also include location detection applications, which may be used to determine a location for the user, such as a mapping, compass, and/or GPS application, which can include a specialized GPS receiver that determines location information for mobile device 140. The other applications may include device interface applications and other display modules that may receive input from the user and/or output information to the user. For example, the other applications may contain software programs, executable by a processor, including a graphical user interface (GUI) configured to provide an interface to the user. The other applications may use components of mobile device 140, such as display devices capable of displaying information to users and other output devices, including speakers.

Mobile device 140 may further include or be associated with database 146, which may store various applications and data and be utilized during execution of various modules of mobile device 140. Database 146 may correspond to different types of data storage and components including cloud computing storage nodes, remote data stores and database systems, distributed database systems over network 160, and the like used to store various applications and data. Database 146 may include, for example, identifiers such as operating system registry entries, cookies associated with application 142 and/or other applications, identifiers associated with hardware of mobile device 140, or other appropriate identifiers, such as identifiers used for user/device authentication or identification, which may be communicated as identifying the user and/or mobile device 140 to transaction processor 130.

Mobile device 140 may include at least one short-range transceiver 148 adapted to communicate with POS device 110, payment terminals 150, and/or other nearby devices, transceivers, and/or components through short-range wireless signaling and communications including NFC communications, RFID communications, Bluetooth, WiFi, infrared scanners and/or communicators, and the like. In various embodiments, short-range transceiver 148 may correspond to microwave, RF, infrared, Bluetooth, and NFC devices and components. In some embodiments, POS device 110 and mobile device 140 may communicate directly, without the use of network 160, for transaction and/or digital receipt processing. In this regard, mobile device 140 may be configured to receive visual data transmissions, such as displays of data, using a display device. Such data displays may include a display of a machine-readable code (e.g., a QR code) having encoded data for the digital receipt and/or webpage. As such, cameras, scanners (including visual, infrared, etc.), and the like may further be used for data transmissions between devices including POS device 110 and mobile device 140.

Mobile device 140 includes at least one network interface component 149 adapted to communicate with transaction processor 130 and/or other devices and servers over network 160. In various embodiments, network interface component 149 may include a WiFi component, a DSL (e.g., Digital Subscriber Line) modem, a PSTN (Public Switched Telephone Network) modem, an Ethernet device, a broadband device, a satellite device and/or various other types of wired and/or wireless network communication devices.

Payment terminals 150 may be implemented as peripheral device, connectable device, handheld device, or the like that may utilize appropriate hardware and software configured for wired and/or wireless communication with POS device 110, transaction processor 130, mobile device 140, and/or other devices and servers for payment processing, purchasing, and/or checkout systems and components. For example, in one embodiment, payment terminals 150 may be implemented as a peripheral device including a card reader, dongle, card swipe or tap component, or the like, which may be limited in functionality and scope of usage, but may also correspond to other devices with additional capabilities including a personal computer (PC), a smart phone, laptop/tablet computer, a wearable computing device, implantable communication devices, and/or other types of computing devices capable of transmitting and/or receiving data. Although only one device is shown, a plurality of devices may function similarly and/or be connected to provide the functionalities described herein.

Payment terminals 150 may include one or more applications and/or components to provide sales and transaction processing features, services, and other operations for use by a merchant with customers and other users during the course of payment processing, which may include merchant sales operations, POS and/or checkout location payment processing, online merchant marketplaces, sales and inventory services, and the like. Payment terminals 150 may engage with transaction processor 130 for use of payment and/or electronic transaction processing services and other computing services provided. In some embodiments, this may include limited device use and/or functionalities for sales, inventory, return or exchange, risk analysis, and other services a merchant may require during the course of their business and sales. In this regard, Payment terminals 150 may correspond to specialized software utilized by a merchant or other user of payment terminals 150 that may provide applications and application data based on the account and/or computing services provided by transaction processor 130. Payment terminals 150 may provide and/or process items for sale with POS device 110, mobile device 140, and/or a user interacting with payment terminals 150 (e.g., using a POS device, the website, mobile application, or another merchant marketplace platform). In certain examples, payment terminals 150 may be accessible over the Internet and provide operations and functionalities for sales and transaction processing with payment terminals 150 over network 160.

In some embodiments, payment terminals 150 may correspond to and/or be used to configure a checkout application at a physical merchant location, such as the application(s) of POS device 110 used to provide sales at a physical location of a merchant. For example, payment terminals 150 may be used to establish a transaction once a user/employee associated with payment terminals 150 has selected one or more items for purchase and/or entered the item(s) to the transaction for processing. Once a payment amount is determined for the item(s) to be purchased by the user, payment terminals 150 may request payment for the transaction. Payment may be provided using electronic transaction processing services enabled and/or provided by transaction processor 130 via POS device 110, as discussed herein.

In this regard, payment may be received from a user and may be processed using POS device 110 and/or transaction processor 130, and payment terminals 150 may interact with POS device 110 for payment processing and/or reading, receiving, and/or processing data. Interactions during payment processing, such as payment instrument reading, may include interactions with another component, such as a payment card, mobile device 140, and the like. Further, in some embodiments, payment terminals 150 may facilitate the transmission and/or exchange of data for digital receipt provision during and/or after transaction processing, such as to provide a message enabling retrieval of a webpage and/or application interface data for a digital receipt. For example, payment terminals 150 may be used to transmit a message over NFC or other short-range wireless communications to mobile device 140. As such, POS device 110, payment terminals 150, and/or mobile device 140 may interact when sending and/or receiving the short-range wireless communications discussed herein to provide data to a digital receipt without requiring and/or requesting identification information, contact identifiers, and the like. After receipt of payment and/or confirmation of the payment, payment terminals 150 may then process a payment to the merchant associated with payment terminals 150 through POS device 110 and/or transaction processor 130.

Although POS device 110 and payment terminals 150 are shown as separate devices interacting, such as a payment terminal and/or card reader with a merchant POS device, it is understood that POS device 110 and payment terminals 150 may be the same device and/or system or one or more components or operations of POS device 110 and payment terminals 150 may be provided by the other device, and vice versa, and/or provided on or within the same device or system.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

FIG. 2 is an exemplary system environment 200 where smart digital receipts transmissible via short-range communications for multi-device data processing sessions are generated and/or used for multi-party transaction processing and other multi-device sessions, according to an embodiment. System environment 200 of FIG. 2 includes POS device 110 interacting with mobile device 140, discussed in reference to system 100 of FIG. 1, to facilitate transmission of data wirelessly and without requiring mobile device 140 and/or a corresponding user to enter an identifier or other user information. The data exchanged may correspond to a message enabling mobile device 140 to retrieve a smart digital receipt, which may include embedded and/or encoded functionalities to allow for transaction splitting between users so that a multi-user transaction may be resolved in separate and secure online sessions between each user's device and transaction processor 130. In this regard, a server backend 220 (e.g., one or more servers and/or backend processors of transaction processor 130 discussed in reference to system 100) may provide webpage and webpage data generation for transactions 124, as well as online sessions.

In system environment 200 of FIG. 2, different interactions, data, and components are shown in order to generate and transmit a digital receipt wirelessly to mobile device 140 from POS device 110 over a short-range wireless communication channel/connection or over a network to an address or account, where the digital receipt is transmitted without corresponding input to POS device 110 and includes additional or expanded transaction processing options and functionalities. Initially, POS device 110 may be used to create, generate, and/or input a transaction, where the transaction may be between a merchant corresponding to POS device 110 and a user utilizing mobile device 140. The transaction may be for purchase of items and/or services from the merchant or an employee of the merchant utilizing POS device 110 to process payment and complete the transaction on behalf of the merchant. As such, display 114 may present information for a transaction 202 having a transaction total 204 including an amount for a first item 206, shown as a “sandwich,” which may generally correspond to any good, product, service, or another item from a merchant. A second item 208, shown as a “salad,” may be included with and/or added to transaction 202, which may be reflected in transaction total 204. A checkout session 210 may correspond to the current check, bill, or another representation and pending or completed invoice for transaction 202, which may require payment of transaction total 204.

Thus, transaction 202 includes multiple items, and may be split between two or more users. Conventionally, this would require splitting of checkout session 210 into separate transactions, including cancelation of transaction 202, or payment by one user and having the users engage in a repayment process offline. However, instead a smart digital receipt having additional or expanded functionalities through embedded processes, links, and/or elements that may be accessible from a webpage and/or presentable in an application may be used for management of split transaction and/or payment processing for transaction 202. A message that enables mobile device 140 to access digital receipt 144 may be transmitted via a short-range wireless interaction between POS device 110 and mobile device 140, such as a “tap to receive” option that does not require the user to enter their contact information and/or identifiers for data exchange. The process to exchange the data may be requested via a selectable option on POS device 110 and/or through a request on one or more of payment terminals 150, which may be provided to one or more users during or post-transaction processing for transaction 202.

For example, communications between POS device 110 and mobile device 140 may be performed via short-range wireless communications, which may be done by placing a corresponding device and/or transceiver (e.g., mobile device 140) within a wireless proximity range to POS device 110 and short-range transceiver 118. This allows for NFC or other short-range wireless communications to exchange data, which may be used for payments, as well as transmissions of message data 226 to mobile device 140, allowing for mobile device 140 to retrieve digital receipt 144. For example, for message data 226, NFC data exchange format (NDEF) may be utilized, which may correspond to a standardized data format specification used for NFC data transmissions. NDEF may be used to encode actions to NFC tags and/or exchange data between devices, which allow for devices to generate and transmit messages having NFC tags that may be trusted and readable for use with certain actions (e.g., navigation to a webpage, opening or loading of content or data in a message content, etc.) and/or reading of NDEF messages by and between devices in a standardized format. As such, an NDEF formatted message, or message in using the NDEF protocol, may enable POS device 110 or other connected device to transmit a message having message data 226 that, when received, opened, and/or processed by mobile device 140, causes digital receipt 144 to load into a browser, application interface, or the like.

A processor 212 of POS device 110 may execute PPA 120, and may generate transaction data 214 for transaction 202, which may include information for first item 206, second item 208, and/or transaction total 204, as well as checkout session 210 for reference of the primary transaction, transaction 202. Processor 212 may correspond to a hardware and/or software processor that may be configured to process data for transaction 202 and track processing of any payments and transactions occurring through online sessions 134 including checkout session 210 and/or separate online sessions with other devices for payment processing. This may be done using the operations of PPA 120, which may include requesting server backend 220 create a webpage for transaction 202 that includes the embedded and/or added transaction processing functionalities for split payment or transaction processing. Webpage data for transaction 202 may be generated and associated with a webpage address for a webpage that may be fetched, retrieved, and/or loaded in a browser, application interface, or the like. In this manner, digital receipt 144 for transaction 202 may be generated.

An XML, HTML, or other data file may be loaded in a browser application or native software application, such as by navigation to a corresponding webpage using a webpage address associated with digital receipt 144 for transaction 202. However, other applications and identifiers for online data retrieval may also be used, such as application interface data for a specific mobile software application of a merchant, transaction processor, or other service provider. Server backend 220 may correspond to a server and data storage system that may process data for transactions 124 and generate corresponding digital receipts retrievable at webpages and/or via webpage addresses or other identifiers. Server backend 220 may generate the digital receipts to have selectable and/or interactable elements, fields, menus, options, and the like that enable electronic transaction processing for all or a portion of each of transactions 124. As such, server backend 220 may further correspond to an online transaction processor or other payment service that may electronically process transaction 202 for creation of digital receipt 144, which may be processed through online sessions 134 to receive payments 128, such as one or more payments for transaction total 204.

In some embodiments, this may correspond to split payments, such as a first payment for first item 206 with corresponding tax, tips, or other fees and costs, and a second payment for second item 208 with similar additional fees and costs. Message data 226 may be generated as an NFC or NDEF message, which may include the webpage address or other link, identifier, or the like to retrieve or access the webpage with corresponding webpage data for digital receipt 144. Thus, one or more webpage interfaces, fields, elements, menus, or the like on mobile device 140 may be populated with digital receipt 144 when message data 226 is received and/or processed. Message data 226 may also or instead correspond to application data, such as data presentable via one or more application interfaces. As such, message data 226 may be presented on mobile device 140 to view digital receipt 144, and may be updated, changed, refreshed, reloaded, or the like as payments 128 for transaction 202 are processed.

To provide message data 226 to mobile device 140, a link to a webpage, network resource, and/or address that may load digital receipt 144 (e.g., a URL for a webpage or a URI/file path to online data for a webpage or application data) may be generated by server backend 220, or may be generated by PPA 120 in other embodiments where webpage address creation may be done by POS device 110. The address or other identifier may be added, inserted, or used to generate message data 226, which may be transmitted to mobile device 140. Transmission may occur via POS device 110, such as via short-range transceiver 118 through transmission 222. Transmission 222 may correspond to a direct data transmission or communication, as well as broadcasts of data that may not be device specific. Further, transmission 222 may cause message data 226 to be received by mobile device 140, which prompts mobile device 140 and/or the corresponding user to open message data 226 and/or view digital receipt 144 via a navigation to a webpage or application data using the link or other data in message data 226. The opening, navigating, and loading of message data 226 and/or digital receipt 144 may be performed automatically on receipt of transmission 222 by mobile device 140.

If transmission 222 fails, display 114 may further be used to display and output a code, such as a barcode or QR code, having encoded data that includes message data 226 and/or the link to retrieve digital receipt 144. Such output may be responsive to a failure to transmit transmission 222, a failure of mobile device 140 to detect transmission 222 and/or a command input on POS device 110 (e.g., a request to end transmission 222 and display the QR code, such as if there is an error or inability to exchange data). Once digital receipt is received by mobile device 140 or has been provided to other computing devices and/or endpoints, received payments 216 may be processed for transaction 202, which may change and update transaction total 204, such as by reducing a total amount due after the payment. Each of received payments 216 may be processed through separate ones of online sessions 134, where online sessions 134 may correspond to private and/or secure communication sessions between individual computing devices of transaction participants and transaction processor 130. Received payments 216 may be provided to processor 212, which may determine which payments have been received and processed. Processor 212 may then perform updates 218 to transaction 202 and/or transaction total 204 based on received payments 216. In unison with performing updates 218, additional updates and/or changes to digital receipt 144 may be made to the corresponding webpage and based on processing payments 128 for transaction 202. This may cause the information presented on digital receipt 144, as well as processes and/or selectable elements (e.g., certain items for selection when paying), to be changed, such as by reducing a transaction total, showing a tip amount currently added by other users, and/or greying out items that have been paid for by other users or in other transactions.

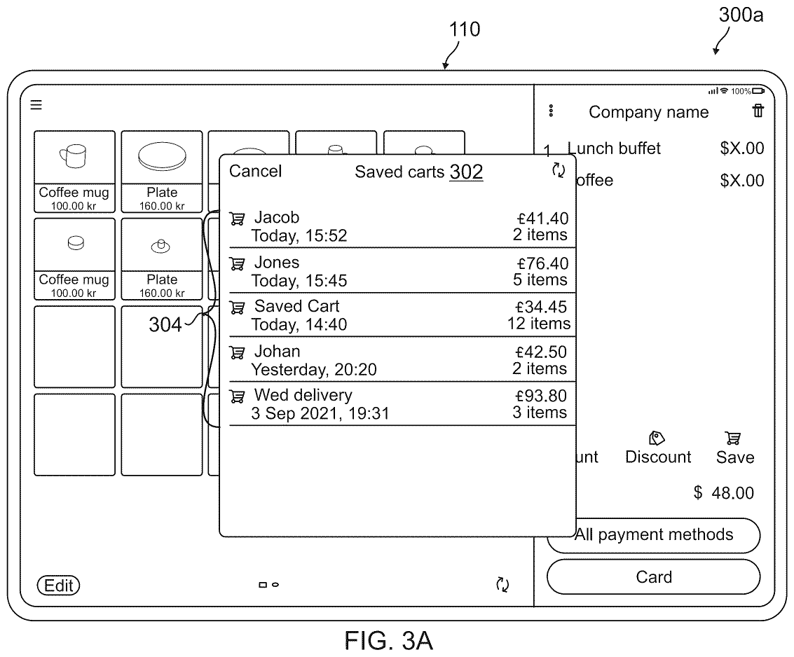

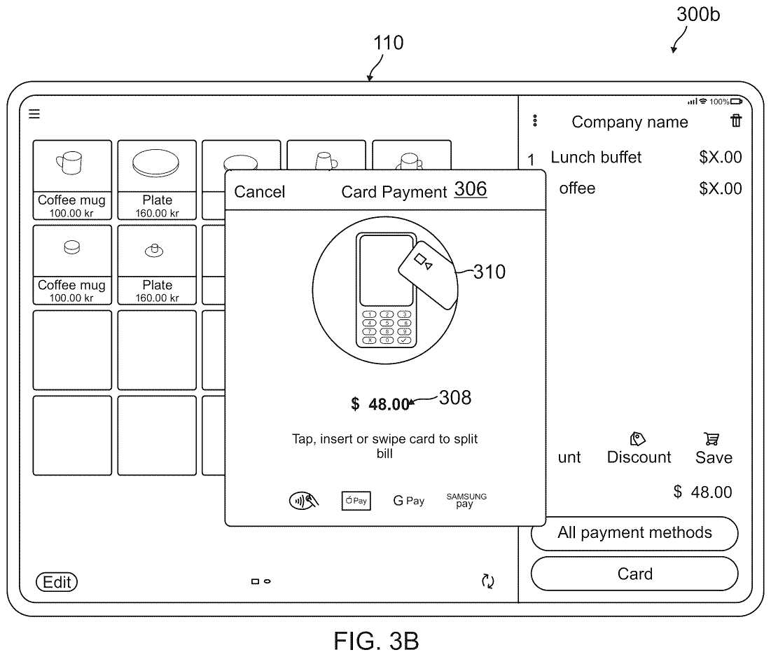

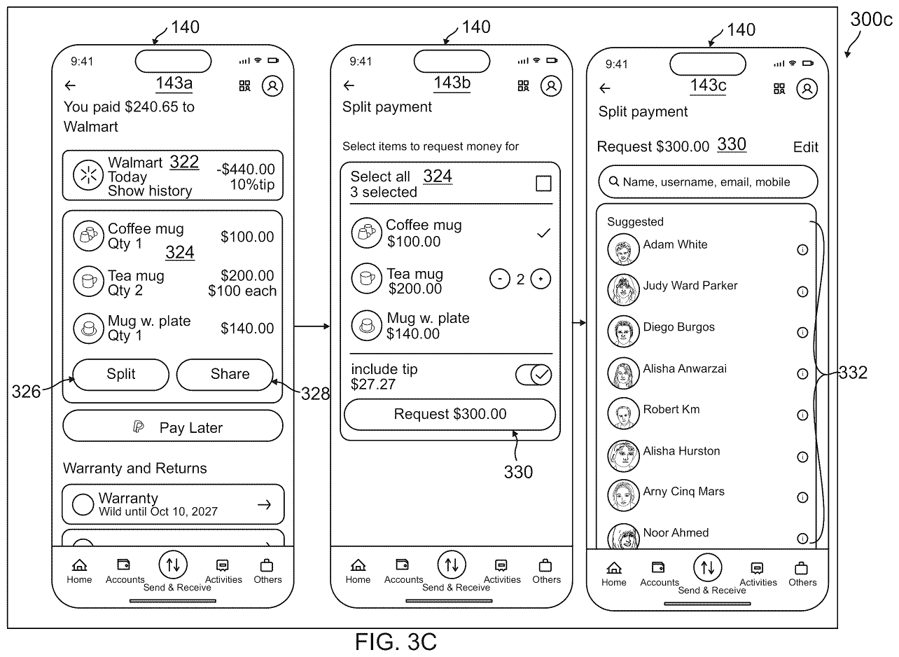

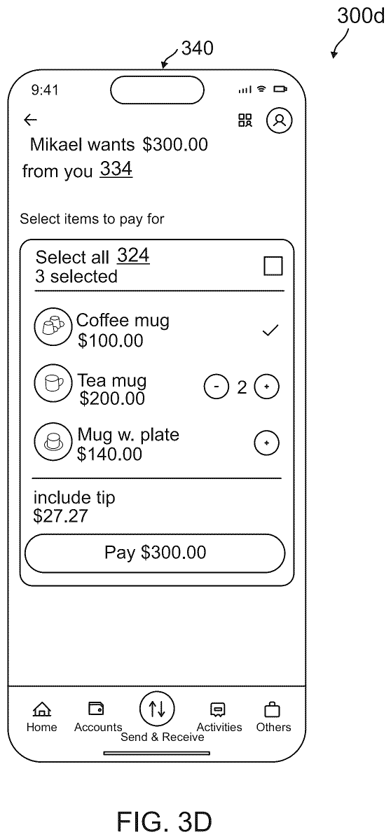

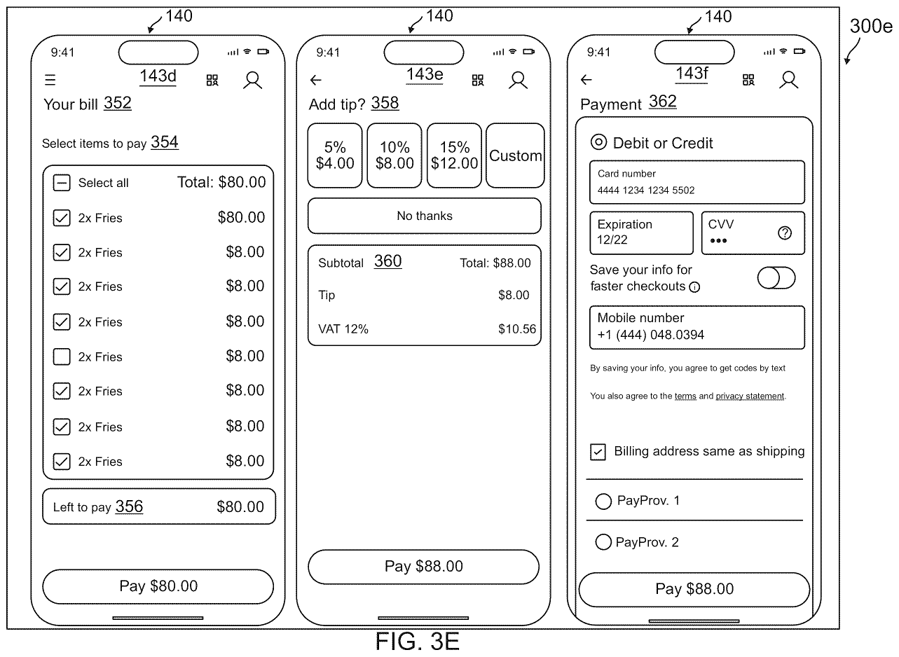

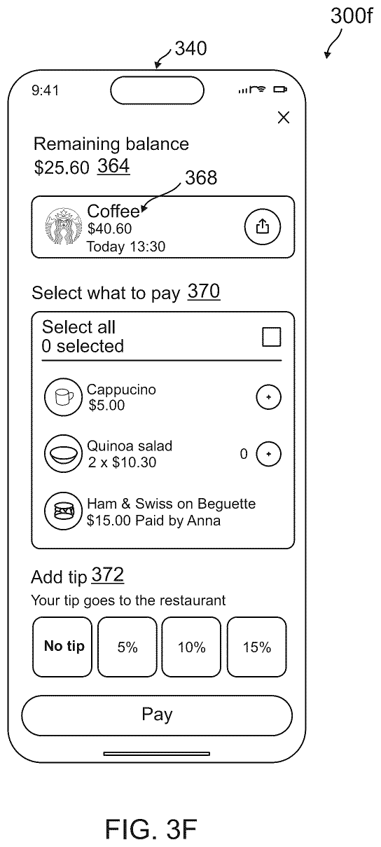

FIGS. 3A-3F are exemplary diagrams 300a-300f of payment terminals and mobile devices with corresponding user interfaces displaying smart digital receipts when connecting to and/or communicating in different sessions for transaction processing, according to an embodiment. For example, diagrams 300a-300f include POS device 110 interacting with mobile device 140, discussed in reference to system 100 of FIG. 1, to facilitate transmission of an order notification via a “tap-to-receipt” or similar tap-to-split or tap-to-pay feature of POS device 110 for transaction processing and digital receipt transmission without requiring a contact identifier or other user information. In this regard, different user interfaces and user interactions to facilitate this data exchange and paging via notifications in user interfaces are shown in diagrams 300a-300f.

In diagram 300a of FIG. 3A, POS device 110 is shown displaying a saved carts interface 302 having digital shopping carts 304 each corresponding to an order, bill, or other invoice or accounting for a transaction to be processed and/or pending processing and payment. POS device 110 may correspond to a checkout and/or payment processing device usable at a merchant location that may allow transaction generation, smart digital receipt transmission, and payment processing for payment instruments of users. In some embodiments, POS device 110 may correspond to a PAYPAL ZETTLE® payment terminal or device. Once a payment amount has been established and/or a payment has been processed, PPA 120 may transition to an interface that requests whether the user would like a notification to be provided on the user's device for digital receipt 144, which allows for split payment processing. Selection of this prompt may initiate a process to generate the smart digital receipt using a transaction processor, including setup and establishment of a webpage for digital receipt 144.

POS device 110 may execute PPA 120 for transaction processing, which may include creating and changing or updating the transaction as items are selected for purchase and/or engaging in transaction review via saved carts interface 302. As such, in diagram 300a, digital shopping carts 304 for the transactions reflect items selected for purchase, and identifies the item cost, transaction total, and/or other information. Each of digital shopping carts 304 may be pending at a certain time, and multiple carts may be pending at once. As such, different payment processing for different ones of digital shopping carts 304 may be performed based on the transaction participants, which may utilize a digital receipt include split transaction processing functionalities. Selection of one of digital shopping carts 304 may allow a user, such as a merchant or merchant employee, as well as a customer when given access to POS device 110, to initiate a digital receipt transmission for split payment processing.

In diagram 300b of FIG. 3B, a user has made a selection from digital shopping carts 304 and may view a card payment interface 306 where the user may be requested to swipe or otherwise provide for reading, a payment card to process a payment for the transaction. Card payment interface 306 includes a total 308 for the transaction, which may require payment from one or more payment instruments. A payment terminal 310, such as one of payment terminals 150 discussed in reference to system 100, may be identified in card payment interface 306 for swiping, tapping, or reading payment cards. A payment may be provided by a customer, or may be input by a merchant or merchant employee, using payment terminal 310 to process one or more payments.

However, it may also be preferrable by customers and other payers, as well as merchants, to process a transaction digitally and/or through multiple payments in a split transaction having sub-transactions or secondary transactions that may each be for a portion of the transaction. Each of these partial payments may be processed through a separate online session with the transaction processor, thereby preserving user information, privacy, financial data, and other sharing of information. As such, card payment interface 306 may include a process to have a smart digital receipt generated, which may include the functionalities, options, and/or processes for split payment processing and separate online session establishment with the online transaction processor. Further, the digital receipt may be transmitted by POS device 110 and/or payment terminal 310 to a user's mobile device within a proximity range, such as a short-range proximity wireless data communication.

In diagram 300c of FIG. 3C, a flow of mobile application interfaces 143a-143c is shown where a mobile device of a user may view a smart digital receipt and engage in split transaction processing by requesting a partial payment from another transaction participant through a contact list or other selection of contact information. While diagram 300c shows user interfaces that may be used to request another transaction participant receive the digital receipt and/or provide the partial payment, that transaction participant may also separately receive the digital receipt, such as through the same or another broadcast of message data over short-range wireless communications by POS device 110 and/or payment terminal 310, and may select the items for purchase and/or enter the partial payment amount through their own mobile device. As such, the other transaction participant may separately engage in use of the digital receipt's functionalities to process a partial payment for the transaction without having a prior request sent to that user.

Mobile application interfaces 143a-c represent transactions in screenshots of interfaces used for transaction processing of split transaction accessed via a smart digital receipt. In this regard, mobile application interfaces 143a-c may be displayed after mobile device 140 has received a smart digital receipt via a message broadcast over a local area, proximity range, and/or short-range wireless communications. As such, digital receipt 144 may be loaded in mobile application interfaces 143a-c of application 142 based on receipt of the message broadcast. The message may correspond to a short-range wireless communication having a message content, body, field, or the like with information enabling retrieval of the data for digital receipt from a webpage or other online resource that provides digital receipt 144 for access and/or retrieval using a filename, pathway, Internet address (e.g., URL or URI), communication identifier or address, or the like.

Proceeding from left to right in diagram 300c, initially on a mobile application interface 143a, digital receipt 144 is presented for an ongoing transaction where one user has paid an initial amount of the transaction, and a total amount is still due and requires payment. In this regard, a cart total 322 for a store corresponding to the smart digital receipt shows a remaining balance for the transaction, and an amount that may be split between multiple users using the processes and functionalities included on or with digital receipt 144. For example, cart total 322 may correspond to a total cost of items 324, including any tax, tip, fees, and the like. Items 324, however, may be selected for purchase by multiple different users, and as such, one or more split transactions may require processing and payment.

In this regard, a split option 326 and a share option 328 may be provided on mobile application interface 143a, which may allow for a user to engage in processes and flows for split transaction processing. With split option 326, a user may designate a portion or split of the transaction to pay for personally or may select and designate another user to pay for that portion of the transaction. As such, split option 326 may be used for personal transaction and split payment processing in a separate online session for secure electronic transaction processing and data entry, but may also be used to send a split transaction and/or split payment request to another user, which may include digital receipt 144 being forwarded to that user. With share option 328, the user viewing mobile application interface 143a may share digital receipt 144 with one or more other users, where each of those users may engage in their own split payment and transaction processing for corresponding portions of the transaction corresponding to cart total 322 and items 324.

In diagram 300c, mobile application interface 143b shows a next interface after selection of split option 326 on mobile application interface 143a. In mobile application interface 143b, item selections are made of items 324, which causes generation of a separate split transaction that may be processed for partial fulfillment of cart total 322. When selecting items 324, the amount due, with any additional costs, fees, or the like, may be separately accounted for in a split, side, or secondary transaction, which is processed separately by the user responsible for purchasing those items and may be tracked with the primary transaction to determine when cart total 322 has been fully paid for and completed. Further when selecting from items 324 for processing in a split transaction, designation of additional costs or fees may be provided by the user creating the split transaction. For example, tip may be added to the split transaction, and the user may also provide an amount for any other accrued fees, taxes that may not be directly applied to their selected items, and the like. Thus, in mobile application interface 143b, the user may create the split transaction from items 324 and/or other transaction data for the primary transaction, and the split transaction may be separately processed in its own online session.

To finalize split payment or transaction creation and assignment to a responsible transaction participant, in mobile application interface 143c, a contact list 332 may be used to select one or more contacts for transmission of the split payment request. Contact list 332 may correspond to an in-app list of friends, contacts, and the like, but may also be imported from and/or extracted and loaded from another application and/or address book or contact list resource. As such, by selecting from contact list 332, the user may have application 142 forward or transmit the corresponding split payment request and split transaction details to the designated address, identifier, account, profile, or the like.

In diagram 300d of FIG. 3D, the recipient of the split payment request and designated payer of the split transaction receives the request and transaction on their corresponding mobile device and displays and/or outputs a split payment notification 334. Diagram 300d provides a mobile application interface of a separate device, a transaction participant device 340, which may be running its own mobile payment application or its own version/copy of the same mobile payment application. In the mobile application interface, split payment notification 334 may provide all or a portion of digital receipt 144, such as a condensed version of the digital receipt to show the selected ones of items 324 that have been requested to be paid by the transaction participant. The mobile application interface in diagram 300d enables a user to process a payment for the split transaction, which may be allocated to cart total 322 and may reduce that total. Further, as items are paid and accounted for through split transaction payments, those items may be removed from the pending transaction and/or open digital shopping cart or may be greyed out or otherwise made un-selectable so that those items are not paid for twice.

In diagram 300e of FIG. 3E, a flow of mobile application interface 143d-143f is shown on transaction participant device 340 where the transaction participant may view a smart digital receipt and split transaction request from another transaction participant to engage in partial payments for a transaction total. In this regard, mobile application interface 143d displays a bill 352 provided and/or assigned to the transaction participant for review, processing, and payment, which may include a list of selected items 354 that were purchased or selected for purchase by the transaction participant. Selected items 354 may be presented in a menu or other interface field that allows the transaction participant to review and confirm payment for those items, and may further allow the transaction participant to refuse payment for certain ones of selected items 354, assign one or more of selected items 354 to another user, or otherwise adjust the split transaction that was initially generated and assigned to the user. A remaining balance 356 of the transaction is included in mobile application interface 143d, which identifies the amount after the partial payment was/is processed from mobile application interface 143d, as well as any other partial payments.

After selection of a pay button or another interface element, mobile application interface 143e may next be displayed in the processing flow, which allows for individual payment processing selections and inputs, as well as separate transaction processing. In mobile application interface 143e, a separate and secure online session may be established by the online transaction processor with the device processing the split transaction. This allows for secure payment without exposure of private or sensitive data to other transaction participants. As such, the online session may have been created or is created for processing of the split transaction for a payment made via mobile application interface 143e. Mobile application interface 143e includes a custom tip field 358 and a split transaction total field 360, where the transaction participant may adjust a tip amount to include a different tip as desired, as well as view a subtotal that the transaction participant is paying in the split transaction. After entering and confirming the subtotal in split transaction total field 360, diagram 300e proceeds to mobile application interface 143f where a payment 362 is processed using entered or stored payment details and/or financial information. Payment 362 may be provided using a payment card as shown but may also be processed using a digital account with a transaction processor and/or corresponding digital wallet.

In diagram 300f of FIG. 3F, another embodiment of a smart digital receipt with functionalities and options for split transaction and payment processing is shown. In this regard, transaction participant device 340 displays the digital receipt during a pre-transaction closure or full payment state, where each transaction participant may individually purchase one or more items through an open digital shopping cart accessible via the digital receipt. In this regard, the digital shopping cart may have items in the cart that can be selected and processed in a split transaction for a partial payment for the transaction, and items may be added and/or removed from the transaction prior to closure and while split transactions are processed.

The interface of transaction participant device 340 in diagram 300f shows a remaining balance 364 for the digital shopping cart that is due and identifies an item 368 that was purchased or requested by the specific user associated with transaction participant 340. Further, the interface presented on transaction participant 340 includes additional items 370 that may be selectable for purchase in the transaction, and a tip field 372 to add a tip to the transaction. Each of these processes may be used to create the transaction that is to be processed and may be split from the transaction into side or secondary transactions for processing from the smart digital receipt. As such, the interface on transaction participant device 340 in diagram 300f may correspond to a digital receipt transmitted to transaction participant device 340 using a message and via short-range wireless communications.

In this regard, a message on POS device 110 may be encoded with, have embedded data for, or otherwise contain information for the notification and/or used to access the notification, such as a URL, URI, file path, or the like. For example, the digital receipt may be generated as a data file or object, which may be loaded via a webpage or user interface having a corresponding webpage address or other link, which may allow storing, hosting, and providing the webpage or user interface to an application for display and output. Such address may be added or embedded to a message field, where the message field includes or causes an executable process on transaction participant device 340 to load or prompt the user to load the webpage address and navigate to the webpage in a browser application on transaction participant device 340, which may be used to load the digital receipt.

In this regard, a message may be generated in HTML and provided over a network as a webpage, may be encoded in an XML file and stored where the HTML encoded webpage may serve as an online backup, may be encoded or provided in a file or message type and sent directly, or may be encoded or provided in a larger file size, such as a Portable Network Graphics (PNG) image type file or the like. In this regard, data size constraints of the file and communication channel (e.g., NFC alone or with network communications using links and locators) may be used to select a file type and/or transmission process. Further, the user may select an option to receive and accept the message, file, and/or notification, which may be used to select the file type and/or transmission process.

Thereafter, the message may be transmitted through short-range wireless communications. The communications may correspond to a short-range transmission by a component on POS device 110 that occurs continuously or periodically over a time period and allows for conveyance of the message to transaction participant device 340. In this regard, transaction participant device 340 may detect the broadcast, which may cause the webpage and/or application data to load on transaction participant device 340 when received. If the broadcast is not detected, POS device 110 may repeat or continue transmission of the broadcast based on one or more commands or may instead move to display a barcode or QR code having encoded data for the digital receipt. Such transmission mechanisms may therefore not require the user to enter a contact identifier. As such, the digital receipt in diagram 300f is shown as may be generated by a transaction processor and merchant POS system or device and conveyed in this manner to be loaded transaction participant device 340.

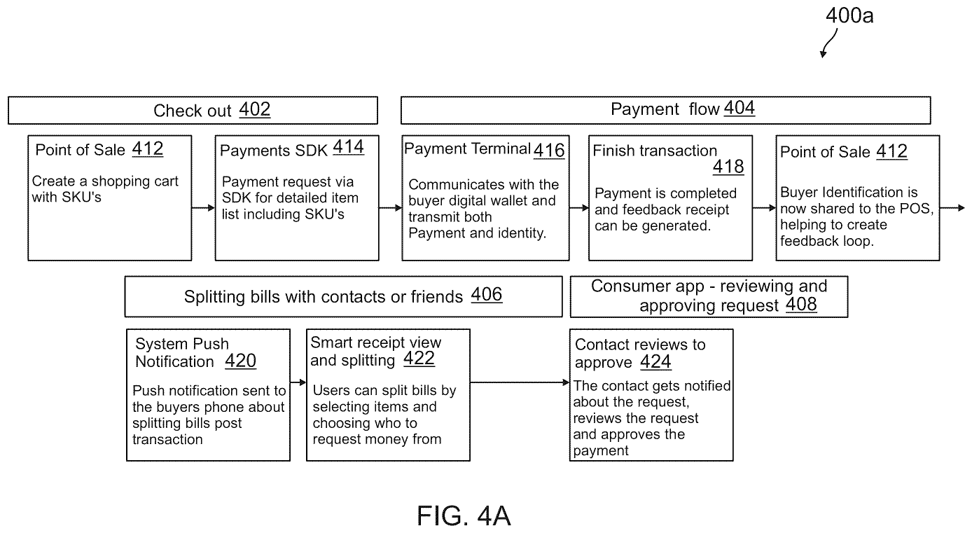

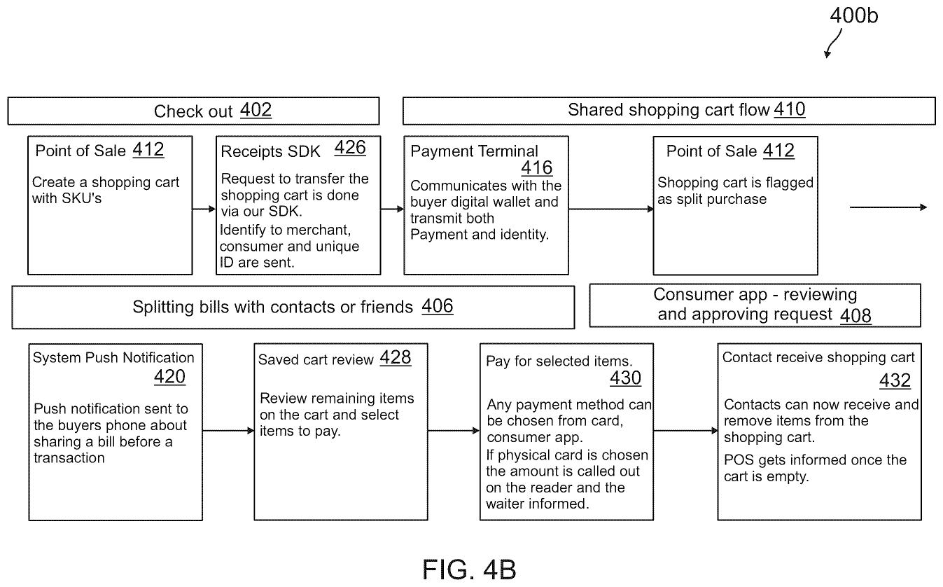

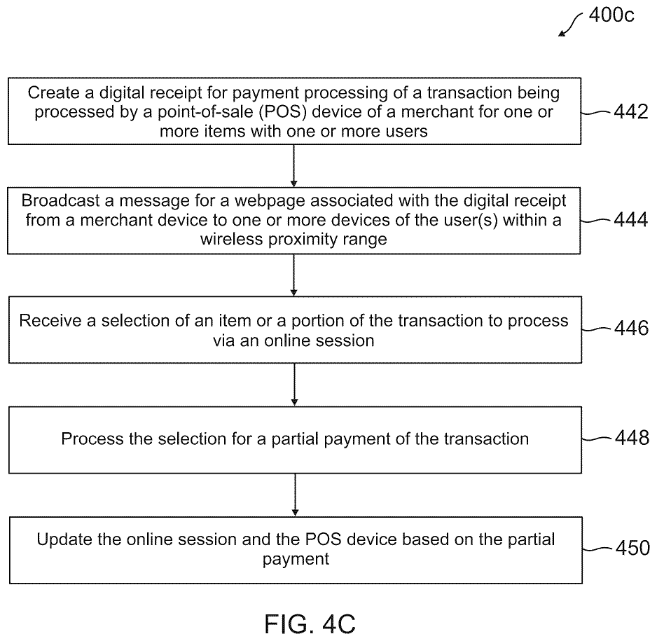

FIGS. 4A-4C are exemplary flowcharts 400a-400c of different processes for generating, transmitting, and using smart digital receipts for multi-device data processing sessions, according to an embodiment. Flowcharts 400a-c represent processes that may be performed by POS device 110, transaction processor 130, mobile device 140, and/or payment terminals 150, such as during the creation and transmission of smart digital receipts for multi-user or multi-payment transactions and other extended or added transaction processing features. Such processes may be used to transmit digital receipt 144 to mobile device 140 using short-range wireless communications including transmission 222, where digital receipt 144 may enable the device, as well as other devices receiving and/or access the receipt, to engage with one or more executable processes and/or features for transaction processing including splitting the transaction, payment due, fees, or the like between multiple payments and/or users. Note that one or more steps, processes, and methods described herein of flowcharts 400a-c may be omitted, performed in a different sequence, or combined as desired or appropriate.

Flowchart 400a in FIG. 4A includes steps executed by transaction processor 130 with POS device 110 and mobile device 140, such as when providing digital receipt 144 to mobile device 140 via transmission 222, as well as initiating payment processing of received payments 216 for transaction 202. In this regard, flowchart 400b represents a post-checkout or post-payment processing of transaction 202 and may be performed after a payment has been made for transaction 202 and/or transaction 202 has been closed with a corresponding merchant. Therefore, flowchart 400b may be utilized by transaction participants that did not provide a payment toward the payment of transaction 202 prior to closure and are instead providing a reimbursement payment to the payer of transaction 202. As such, different portions of the steps of flowchart 400a are shown as being performed by, on, or with POS device 110, transaction processor 130, and mobile device 140.

At step 402 of flowchart 400a, checkout is initiated for a transaction and involves use of a POS 412 to create a shopping cart with a stock keeping unit (SKU) or other unique identifier of items being added to or included in a transaction for payment and processing. POS 412 may correspond to POS device 110 or may correspond to other types of checkout and/or POS devices, applications, websites or online digital platforms, and the like. For example, POS 412 may be used to create digital shopping carts for items digitally, instead of performing entry of items physically selected for purchase (as well as entered to a transaction, such as by scanning an item barcode for the SKU) at a merchant location. A payments software development kit (SDK) 414 provided by the online transaction processor or other payment processor may be used to generate, format, or otherwise determine, for use with the online transaction processor, payment requests and other API calls or requests for payment processing, such as based on the detailed item list including the SKUs of the items.

At step 404, a payment flow is then initiated by payments SDK 414 after payment request generation for the transaction. The payment flow may be performed for processing of the payment request and transaction for the items from payments SDK 414. During step 404, a payment terminal 416 may be used to communicate with a buyer digital wallet and transmit a selected payment that is provided by the buyer and to be used for payment processing of the payment request, as well as an identity of the buyer for authentication, verification, and/or risk and fraud assessment purposes. In this regard, payment terminal 416 may correspond to a handheld device or the like that may be used to communicate with a mobile device, such as a mobile smart phone, of the buyer to receive a digital wallet token, payment token, short-range transmission of payment information and/or identity information, and the like. Payment terminal 416 may communicate the data to POS 412, which may process the payment provided for the transaction using the transaction processor or other payment processing network and/or online processor.

After use of payment terminal 416 during step 404, a transaction completion 418 may conclude the transaction with POS 412, which ends the involvement of POS 412 and corresponding merchant. Transaction completion 418 provides proof of payment to POS 412, and POS 412 may generate transaction and/or receipt data for digital receipt creation. Further, POS 412 may receive information sufficient to identify the buyer for receipt generation and/or transmit a message enabling the buyer's mobile device to access the digital receipt. The digital receipt may be generated as a webpage or other accessible online data that may be retrieved and loaded in a browser, interface, or the like, and may include added functionalities, elements, processes, and/or embedded features for split transaction processing and multiple payments. As this time, the transaction has been completed with POS 412 and the merchant, but requires reimbursement, repaying, or other types of further transactions to be processed to make the original payer of the transaction whole again, that is, to provide them the amount due from the other transaction participants.

As such, POS 412 may provide the digital receipt to the buyer through a broadcast over short-range wireless communications within a local area, proximity range, set distance or threshold distance, or the like, where the broadcast may include a message in a messaging and/or data exchange format for short-range wireless communications that causes the digital receipt to be retrieved by and/or loaded in an interface of the buyer's mobile device. At step 406, bill splitting with friends or other contacts is performed based on this digital receipt. A push notification 420 may inform the buyer that the digital receipt is capable of use for splitting the transaction, payment, fees, or other portion/partial payment for the bill that the buyer recently paid. A smart receipt view 422 may be provided that displays the smart receipt in a browser, user interface, or the like and allows for splitting through selection of items, payment amounts, and the like. Smart receipt view 422 may establish a private and/or secure online session for the buyer's device, or other transaction participant receiving and viewing the digital receipt, and transaction processor so that payments may be made securely and privately. As such, each online session may allow for payment processing without exposure of financial information or payment instruments, additional fee payments, and/or other transaction information that may be privately selected by each user from being revealed to other users.

At step 408, a customer or consumer application review occurs, where each payer may receive and review a contact payment approval 424 that is requested from one or more other transaction participants (e.g., the original payer, or other user that may have received the digital receipt). Once other transaction participants have been identified, a request for payment for a designated portion of the transaction may be sent to their provided contact information. Additional capabilities may be provided with the smart digital receipt to identify other users to pay certain portions of the bill and enter, select, or provide contact information, such as a phone number, email address, username, or other contact identifier, for a request for that portion, as well as a view of the smart digital receipt or other transaction data, to be sent. As such, contact approval 424 may transmit a payment request through a separate online session than that of other transaction participants.

Flowchart 400b in FIG. 4B includes steps executed by transaction processor 130 with POS device 110 and mobile device 140, such as when providing digital receipt 144 to mobile device 140 via transmission 222, as well as initiating payment processing of received payments 216 for transaction 202. As discussed above, flowchart 400a represents a pre-checkout or pre-payment processing of transaction 202, and may be performed prior to completion and/or finalization of transaction 202 including a full payment for transaction 202 and closing of transaction 202. Flowchart 400b shows different portions of steps being performed by, on, or with POS device 110, transaction processor 130, and mobile device 140. Flowchart 400b may proceed with several steps in a similar manner to flowchart 400a, and as such, those steps are summarized below. Any important distinctions are highlighted in each step as follows.

Flowchart 400b similarly begins with step 402, where POS 412 creates a shopping cart with SKUs. Instead of payments SDK 414 being used, a receipts SDK 426 for pre-transaction completion digital receipt generation is utilized to request a transfer of the shopping cart and pending transaction to the online transaction processors system and/or applications for invoicing, transaction processing, digital shopping carts, and/or smart digital receipts. Receipts SDK 426 may therefore correspond to an SDK for an application of POS 412 that enables conversion and/or moving of a pending transaction from POS 412 of the merchant to a corresponding transaction processing application and/or system of the online transaction processor.

At step 410, a shared shopping cart flow is performed where receipts SDK 426 interfaces with payment terminal 416 to obtain identity information from a digital wallet of one of the buyers, which may be used to associate the pending transaction with a particular user for bill splitting and contact forwarding purposes. POS 412 may then be flagged with information indicating the transaction and bill is to be split, and transaction processing may be paused or held pending completion of the bill splitting process and separate payments. Step 410 returns to step 406 from flowchart 400a where the bill splitting process amongst friends or other contacts is performed. During step 406, push notification 420 is again used to inform the buyer of the bill splitting capabilities on and/or usable through or with the smart digital receipt. However, at step 406 in flowchart 400b, instead of a paid and completed transaction being recorded and identified on the smart receipt, a saved cart review 428 is performed of the digital shopping cart for the current pending transaction.

Saved cart review 428 may allow for different transaction participants to review items in the digital shopping cart, as well as make selections of the items for payment, an amount (e.g., a value, percentage, portion or ratio with respect to the other users, etc.) of the bill to pay, and/or any additional or separate tax, tip, or other transaction fees or costs to pay (which may be added on top of the standard or agreed upon amount for a state/local/national tax, customary or preauthorized/established tip amount, etc.). Each of the payers may perform a separate iteration or version of saved cart review 428 for their own purchases, and each of these performances of saved cart review 428 may occur through a separate online session between that payer's device and the online transaction processor.

As such, a selected item payment 430 may occur multiple times during step 406, and for each sub-payment or partial payment of the total due for the transaction. Selected item payment 430 may occur through these separate online sessions and may account for a portion of the transaction, after which the transaction, including total due, items purchased or still owed payment for, tip amount, etc., may be updated for the transaction and/or when the smart digital receipt is accessed, refreshed, and/or viewed. At step 408, customer or consumer application review is similarly performed for the transaction participants, where a contact shopping cart receipt 432 occurs and the contacts receive the digital shopping cart. The cart may then be tracked via the digital receipt, which may be shown and provided in-application, and items may be added, removed, selected for payment, or otherwise processed to complete the shopping cart. At step 408, POS 412 may be informed when the shopping cart is empty (all items have been paid for or removed from purchase) so that the corresponding transaction with the merchant's system may be closed and completed.

Flowchart 400c in FIG. 4C includes steps executed by transaction processor 130 with POS device 110 and mobile device 140, such as when providing digital receipt 144 to mobile device 140 via transmission 222, as well as initiating payment processing of received payments 216 for transaction 202. Flowchart 400c represents steps that may be performed during smart digital receipt creation, transmission, and/or use for transactions processed at POS devices, where mobile devices of users may be used to wirelessly receive the smart digital receipts through short-range wireless communications anonymously or without providing contact and/or identifying information. As such, different portions of the steps of flowchart 400c are shown as being performed by, on, or with POS device 110, transaction processor 130, and mobile device 140.

At step 442, a digital receipt for payment processing of a transaction processed or being processed by a point-of-sale (POS) device of a merchant for one or more items with one or more users, for example, using an enhancment, proceess, or feature provided by, on, or with the digital receipt. A transaction may be pending processing or have been processed at a merchant device, such as a POS device, for one or more purchases and/or payments between a user and a merchant. For example, POS device 110 in system 100 of FIG. 1 may receive transaction data, such as from user input, item barcode or other SKU scans or data entry, and/or digital communications for item purchase requests, and may process the transaction using payment processing services of transaction processor 130. In some embodiments, mobile device 140 may also provide and/or process the transaction data, such as by providing a digital token or payment information for payment processing. Such interactions may also be shown by POS device 110, mobile device 140, and server backend 220 in system environment 200 of FIG. 2.

Prior to or on completion of the transaction (e.g., payment processing and approval or declination based on insufficient funds, fraud detection or risk assessments, etc.), the merchant's device used for checkout and payment may display or output an option to provide a digital receipt to the user, which records the transaction or otherwise provides a history of the transaction (e.g., time, date, merchant information, items/services, prices and other costs or totals, etc.). Where the transaction has not been completed, the digital receipt may provide a pending digital shopping cart for one or more users to process individual transactions for items in the cart or other payments. However, if completed, the digital receipt may include processes for repayment or reimbursement of a payer by other transaction participants. As such, the merchant may offer the user an option to receive notifications via mobile device 140, which may be done so by having mobile device 140 “tap” or brought near POS device 110 for data exchange.

For digital receipt creation and/or transmission, a webpage and/or data file for the notification and status tracking maybe generated by creating a PDF file, image and/or image file (e.g., PNG, JPEG, etc.), or the like that may include information from the transaction and fields that may be updated and/or is dynamic to track different payments, items in the transaction, payers, and the like. Further, the webpage and/or data file may include embedded features and/or processes, or other included elements and options, usable to process partial payments for the transaction, such as selection of one or more items and transaction processing through a separate online session between the requesting device of the buyer/payer/transaction participant, and transaction processor 130. As such, the digital receipt may correspond to different webpage and/or application interface data that may be displayed in an application on the user's mobile device. In this regard, a webpage may be generated as an XML or HTML file, which may be accessible and loaded when navigating to a webpage address. Other data containers, files, and online addresses may also be utilized. For example, application interface data may be generated that may be populated in an application of the merchant and/or transaction processor, as well as pushed to the mobile device of the user. As such, a data file and link, address, or identifier may be generated that allows for notifying a user of an order status and tracking order fulfillment in a web browser application or other software application on the user's mobile device.

An address or link to the webpage and/or data file may be generated or determined that allows for transmitting, providing, and/or loading the digital receipt on a computing device, such as a mobile device of a user. For example, a webpage address or link to a webpage with a webpage file (e.g., HTML or XML) may be created, however other files and formats also be used. The data may be hosted via a webpage and/or stored in an online storage, such as a cloud-based or other large data storages that may store data with corresponding identifiers allowing for data retrieval. A message may also be generated for transmission using a short-range wireless protocol and messaging format, such as NDEF or the like. The message may be generated by adding, embedding, or otherwise providing the address, link, or other identifier for retrieval of the notification via the webpage or application data. For example, a messaging or data transmission protocol for short-range wireless communications may allow the webpage address, a link, and/or executable command or operation to be embedded, added, or included in a data field of the digital receipt. The field may correspond to a header, message body, or the like, and may cause a device receiving the message to open or execute an application and load the digital receipt or navigate to the webpage and/or application interface data that allows the application to load the digital receipt.

At step 444, a message is broadcast for a webpage associated with the digital receipt from a merchant device to one or more devices of the user(s) within a wireless proximity range. The merchant device may correspond to one or more of POS device 110, payment terminals 150, or any other component, device, server, or the like associated with a merchant. In this regard, the merchant device may not require the user to enter a contact identifier, such as a name, phone number, email address, or the like. This may may be done to ensure and protect the privacy of the user and limit or minimize spam and other unwanted communications by the merchant or another entity that may receive and/or access the user's preferred contact identifier. As such, message data enabling retrieval and/or loading of the digital receipt may be transmitted to a device of the user via short-range wireless communications. For example, POS device 110 in system 100 of FIG. 1 may broadcast, or otherwise transmit in a directed or undirected manner, a message (e.g., NFC tap message) for the digital receipt to mobile device 140. Broadcasting may be performed for a set period of time over the short-range wireless communications using a corresponding short-range wireless protocol.

In this regard, a wireless transceiver of the payment terminal, POS device, or other merchant device may begin to transmit the message, such as continuously or periodically, for a time period with an instruction for the user to place their mobile, wearable, or other device within a proximity to merchant's device. The option to extend or rebroadcast may also be provided on the merchant's device at or near the end of the broadcast. If transmission and receipt of the message and corresponding digital receipt is not performed or does not occur, such as if the mobile device cannot or does not receive the message, another option to transmit the message and/or digital receipt may occur. For example, POS device 110 may display a barcode or QR code that includes encoded data for the webpage and/or application interface. Once the message is received by mobile device 140, or other device, the message data, content, fields, or the like may be processed and/or used to load the digital receipt in the corresponding application on mobile device 140, such as in a browser of a web browser application, in an application user interface of a native software application, or the like.

At step 446, a selection of an item or a portion of the transaction to process via an online session is received. Digital receipt 144 may be loaded on mobile device 140, which may correspond to one of the transaction participants, as well as the devices of other transaction participants. Each may view the items requiring payment for transaction closure or reimbursement/repayment to a payer after transaction closure. In this manner, each participant and payer may make a selection of one or more of individual items 125 to process one of payments 128 for through one of online sessions 134. Selections may update the transaction, such as by indicating which items have been selected, as well as by whom, and may be used to establish a separate secure one of online sessions 134 for payment processing and item checkout and purchasing/repaying.

At step 448, a partial payment of the transaction is processed based on the selection. Payments 128 may be made during online sessions 134 based on these separate selections of a subset of items in a corresponding one of transactions 124, which performs partial transaction processing and payment. In this regard, transaction processor 130 may process multiple partial payments to account for each transaction participants purchases, and fulfillment of transaction processing and/or reimbursement may occur based on these selections. When the selections are made, separate sub-transactions may be created and processed during online sessions 134, which each may be attributed their portion of total transaction taxes, tips, or other costs/fees.

At step 450, the online session and the transaction is updated based on the partial payment. As each of the partial payments are processed, the main transaction may be updated to reflect the corresponding payments and/or reimbursements. Items may be removed or greyed out as purchased or having repayment made, and any tax, tips, or the like currently added may be shown (where excess meant for a server or other service provider may be shown or omitted if requested by the payer). The transaction total may reflect the changes to the transaction and the payments made, for example, by having received payments 216 affect an output of transaction 202 and/or transaction total 204 on display 114. Further, received payments 216 may cause updates 218 to be generated and processed for updating transaction 202 and/or digital receipt 144 on corresponding devices.

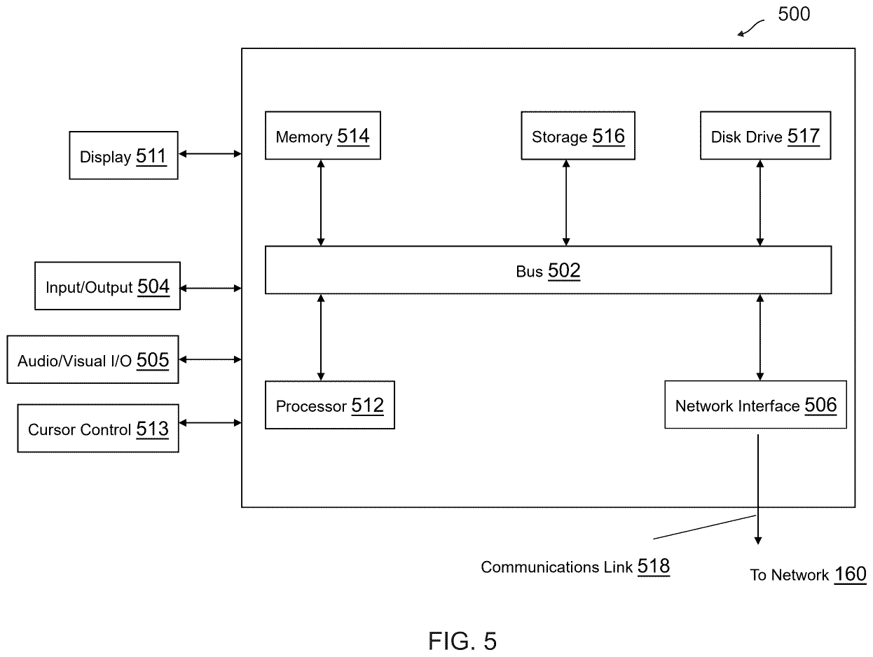

FIG. 5 is a block diagram of a computer system 500 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows. For example, POS device 110, transaction processor 130, mobile device 140, payment terminals 150, and/or one or more of the servers, devices, or other components in system 100 of FIG. 1 may be implemented by computer system 500.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising:
receiving data for a transaction being processed using a merchant device, wherein the data comprises one or more items for purchase;
creating a first online session for processing of the data via a webpage, wherein the first online session is created with an identifier enabling one or more devices to access the webpage and process the transaction during the first online session;
causing the merchant device to broadcast a short-range wireless communication that includes the identifier and a first executable option that enables the one or more devices receiving the short-range wireless communication to load the webpage;
receiving, from a first device during the first online session, a first transaction processing request for at least a first portion of the transaction, wherein the first transaction processing request designates at least one item of the one or more items for a payment using a payment instrument provided by the first device;
processing the first transaction processing request for the at least the first portion of the transaction using the payment instrument;
updating the first online session to reflect that the at least one item has been purchased by a first user of the first device based on the processing the first transaction processing request; and
transmitting a notification that updates the transaction based on the updated online session to the merchant device and the first device.

2. The method of claim 1, wherein the creating the first online session comprises:
generating the webpage and the identifier for the transaction, wherein the webpage includes the transaction data and a second executable option for processing the first transaction processing request, and wherein the identifier comprises at least one of a unique identifier usable by a mobile application or a uniform resource locator (URL) usable by a browser application; and
providing the webpage over a network that enables an access to the transaction using the identifier.

3. The method of claim 2, wherein the causing the merchant device to broadcast the short-range wireless communication comprises:
transmitting, to the merchant device, message code having the identifier embedded in the message code, wherein the message code enables the one or more devices to load the webpage using the identifier, and wherein the message code requests that the merchant device broadcast the message code via the short-range wireless communication.

4. The method of claim 3, wherein the message code comprises at least one of a near field communication (NFC) data token comprising the identifier without a message file attachment or a quick response (QR) code comprising displayable encoded data for the identifier.

5. The method of claim 1, further comprising:
generating a digital receipt for the transaction and having the first executable option; and
updating the digital receipt in real-time based on the first transaction processing request and an addition or a deletion of the one or more items to the transaction.

6. The method of claim 1, further comprising:
receiving, from a second device during a second online session established with the second device based on the second device access the webpage, a second transaction processing request for at least a second portion of the transaction; and
updating the second online session based on the first transaction processing request and the second transaction processing request.

7. The method of claim 6, wherein the transaction comprises a split transaction between a plurality of users, and wherein the method further comprises:
determining that all of the one or more items in the split transaction have been paid for by the plurality of users; and
updating a third online session with the merchant device to indicate that the split transaction has been paid for by the plurality of users.

8. The method of claim 1, wherein the short-range wireless communication comprises an in-application notification publishable in a plurality of different mobile applications and comprising a link to the webpage using the identifier that enables each of the plurality of different mobile applications to split a plurality of payments for the one or more items in the transaction.

9. A system comprising:
a non-transitory memory; and
one or more hardware processors coupled to the non-transitory memory and configured to execute instructions to cause the system to:
receive data for a transaction generated at a merchant device for one or more items for purchase, wherein the data includes a total of the transaction based at least on the one or more items;
create an online session for processing one or more payments for the total via a webpage, wherein the webpage is accessible via a uniform resource locator (URL);
generate a digital receipt comprising the data, the URL, and an executable option that causes, after selection, one or more devices to access the webpage via the URL;
cause the merchant device to broadcast the digital receipt over short-range wireless communications;
detect a navigation to the webpage by a mobile device of a user based on the URL; and
load the webpage on the mobile device.

10. The system of claim 9, wherein the online session is one of a plurality of online sessions, and wherein each session of the plurality of online sessions is between a computing device of a corresponding transaction participant and the system for processing one of the one or more payments.

11. The system of claim 10, wherein each session of the one or more online sessions corresponds to a secondary transaction from the transaction, and wherein the secondary transaction for each session is for a purchase of a subset of the one or more items from the transaction.

12. The system of claim 11, wherein, on completion of the secondary transaction in each session, executing the instructions further causes the system to:
update the transaction based on the subset of the one or more items purchased; and
cause the updated transaction to be refreshed in each session of the plurality of online sessions.

13. The system of claim 9, wherein executing the instructions further causes the system to:
process a payment of the one or more payments for the transaction during the online session with the mobile device.

14. The system of claim 13, wherein, prior to processing the payment, executing the instructions further causes the system to:
receive a selection from the one or more items for purchase by the payment;
determine the payment for processing based on the selection.

15. The system of claim 13, wherein processing the payment is performed through a separate transaction from the transaction and the payment is attributed to the total for the transaction.

16. The system of claim 9, wherein the digital receipt comprises executable options embedded on the webpage via corresponding elements that are selectable to cause a transaction processing operation for the one or more payments to be performed.

17. A merchant device comprising:
a reader component configured to read payment data;
a short-range wireless transceiver configured to receive at least one of the payment data or digital wallet data and broadcast messages via short-range wireless communications;
a non-transitory memory; and
one or more hardware processors coupled to the non-transitory memory and configured to execute instructions from the non-transitory memory to cause the merchant device to:
generate a transaction for one or more items for purchase, wherein the transaction includes data comprising a total of the transaction based at least on the one or more items;
create a digital receipt for the transaction with an online transaction processor that enables the online transaction processor to process one or more payments for the total via a webpage and during one or more online sessions with one or more devices, wherein the webpage is accessible via a uniform resource locator (URL);
determine a message having message data corresponding to the digital receipt, wherein the message data enables a mobile device to access the webpage via the URL and load the digital receipt in one of a browser or an application interface;
broadcast the message over short-range wireless communications;
receive an indication of a first payment of the one or more payments for the total; and
update the transaction and the total based on the first payment, wherein the updated transaction and the total enables the digital receipt to be updated on the webpage.

18. The merchant device of claim 17, wherein at least a second payment causes the total for the transaction to be met, and wherein executing the instructions further causes the merchant device to:
close the transaction; and
mark the digital receipt as the transaction being completed.

19. The merchant device of claim 17, wherein executing the instructions further causes the merchant device to:
rebroadcast the message over the short-range wireless communications based on one of a request for rebroadcasting the message or a number of payers requesting the message data for access to the digital receipt.

20. The merchant device of claim 17, wherein executing the instructions further causes the merchant device to:
remove at least one item of the one or more items from the transaction based on the first payment.
